(19) United States
(12) Patent Application Publication
(10) Pub. No.: US 2010/0237931 A1
(43) Pub. Date: Sep. 23, 2010

(54) INTERNAL POWER SUPPLY VOLTAGE GENERATION CIRCUIT

(75) Inventors: Ryu OGIWARA, Yokohama-Shi (JP); Daisaburo TAKASHIMA, Yokohama-Shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/727,123

(22) Filed: Mar. 18, 2010

(30) Foreign Application Priority Data
Mar. 19, 2009 (JP) 2009-67441
Feb. 1, 2010 (JP) 2010-20378

(51) Int. Cl. G05F 1/10

(52) U.S. Cl. 327/536

(57) ABSTRACT

An internal power supply voltage generation circuit 100 has a first charge pump circuit which steps up the external power supply voltage in response to the first clock signal and outputs a first stepped up voltage from the first voltage stepup output terminal; a second charge pump circuit which steps up the first stepup voltage in response to the second clock signal and outputs a second stepped up voltage from the second voltage stepup output terminal, the second stepped up voltage being higher than the first stepped up voltage; a first voltage stepdown circuit which steps down the first stepped up voltage and outputs a first stepped down voltage; and a second voltage stepdown circuit which steps down the second stepped up voltage and outputs a second stepped down voltage, the second stepped down voltage being higher than the first stepped up voltage.

### CROSS-REFERENCE TO RELATED APPLICATIONS

This application is based upon and claims the benefit of priority from the prior Japanese Patent Application No. 2009-67441, filed on Mar. 19, 2009, and No. 2010-020378, filed on Feb. 1, 2010, the entire contents of which are incorporated herein by reference.

### BACKGROUND OF THE INVENTION

1. Field of the Invention

The present invention relates to an internal power supply voltage generation circuit applied to LSI circuits such as semiconductor memories of which low voltage operation is required.

2. Background Art

In recent years, for LSI circuits such as semiconductor memories, a power supply which outputs a lower voltage is demanded. And the output voltage of the power supply is lowered although the threshold voltage cannot be scaled by existence of leak currents in the LSI circuits.

Accordingly, it is considered to step up an external power supply voltage by using a voltage stepup (boost) circuit and generate an internal stepped down voltage by using the stepped up voltage.

For conducting the stepup in this case, however, it is necessary to consume charges supplied from an external power supply voltage VDD. For example, for stepup corresponding to charges of nearly 1, consumption of charges of at least 2 is needed.

In other words, for using the stepped up charges as an internal power supply voltage source, an efficient charge consumption method is needed.

In some conventional semiconductor devices, an external power supply voltage is stepped up by using two charge pump circuits and the external power supply voltage is stepped down by using two voltage stepdown (buck) circuits to generate a plurality of internal power supply voltages (see, for example, JP-A 2003-132679 (KOKAI)).

In the conventional semiconductor devices, the voltages stepped up by the charge pump circuits are not stepped down, in consideration of the internal power supply voltage to be used by the voltage stepdown circuits, and charges are not consumed efficiently.

### SUMMARY OF THE INVENTION

According to one aspect of the present invention, there is provided: an internal power supply voltage generation circuit comprising:

a first charge pump circuit which comprises a first MOS transistor connected at a drain thereof to a first voltage stepup input terminal supplied with an external power supply voltage, a second MOS transistor connected at a drain and a gate thereof to a source of the first MOS transistor and connected at a source thereof to a first voltage stepup output terminal, and a first MOS capacitor connected at a gate thereof to the source of the first MOS transistor and supplied at a source and a drain thereof with a first clock signal, and which steps up the external power supply voltage in response to the first clock signal and outputs a first stepped up voltage from the first voltage stepup output terminal;

a second charge pump circuit which comprises a third MOS transistor connected at a drain thereof to a second voltage stepup input terminal supplied with the first stepup voltage, a fourth MOS transistor connected at a drain and a gate thereof to a source of the third MOS transistor and connected at a source thereof to a second voltage stepup output terminal, and a second MOS capacitor connected at a gate thereof to the source of the third MOS transistor and supplied at a source and a drain thereof with a second clock signal, and which steps up the first stepup voltage in response to the second clock signal and outputs a second stepped up voltage from the second voltage stepup output terminal, the second stepped up voltage being higher than the first stepped up voltage;

a first voltage stepdown circuit which steps down the first stepped up voltage and outputs a first stepped down voltage; and

a second voltage stepdown circuit which steps down the second stepped up voltage and outputs a second stepped down voltage, the second stepped down voltage being higher than the first stepped up voltage.

According to another aspect of the present invention, there is provided: an internal power supply voltage generation circuit comprising:

a first charge pump circuit which steps up an external power supply voltage and outputs a first stepped up voltage from a first voltage stepup output terminal;

a second charge pump circuit which steps up the first stepup voltage and outputs a second stepped up voltage from a second voltage stepup output terminal, the second stepped up voltage being higher than the first stepped up voltage;

a first voltage stepdown circuit comprising a first MOS transistor which is an nMOS transistor connected between a first voltage stepdown input terminal supplied with the first stepped up voltage and a first voltage stepdown output terminal, a second MOS transistor which is an nMOS transistor connected between the first voltage stepdown input terminal and the first voltage stepdown output terminal and connected at a gate thereof to a gate of the first MOS transistor, and a third MOS transistor which is a pMOS transistor connected between the first voltage stepdown input terminal and the first MOS transistor, the first voltage stepdown circuit stepping down the first stepped up voltage and outputting a first stepped down voltage from the first voltage stepdown output terminal; and

a second voltage stepdown circuit comprising a fourth MOS transistor which is an nMOS transistor connected between a second voltage stepdown input terminal supplied with the second stepped up voltage and a second voltage stepdown output terminal, a fifth MOS transistor which is an nMOS transistor connected between the second voltage stepdown input terminal and the second voltage stepdown output terminal and connected at a gate thereof to a gate of the fourth MOS transistor, and a sixth MOS transistor which is a pMOS transistor connected between the second voltage stepdown input terminal and the fourth MOS transistor, the second voltage stepdown circuit stepping down the second stepped up voltage and outputting a second stepped down voltage from the second voltage stepdown output terminal, the second stepped down voltage being higher than the first stepped up voltage,

wherein a gate voltage of the first MOS transistor is higher than the external power supply voltage and is lower than the first stepped up voltage, and

a gate voltage of the fourth MOS transistor is higher than the first stepped up voltage and is lower than the second stepped up voltage.

### BRIEF DESCRIPTION OF THE DRAWINGS

FIG. 1 is a block diagram showing an example of a memory system 1000 including an internal power supply voltage generation circuit 100 according to a first embodiment which is a mode of the present invention;

FIG. 2 is a circuit diagram showing an example of a configuration of the power-on detection circuit 1 shown in FIG. 1;

FIG. 3 is a diagram showing an example of a configuration of the band gap reference circuit 2 and the reference potential generation circuit 3,

FIG. 4 is a circuit diagram showing an example of a configuration of the VPP_{Low} generation circuit (charge pump circuit) 4 shown in FIG. 1;

FIG. 5 is a circuit diagram showing an example of a configuration of the VPP_{High} generation circuit (charge pump circuit) 5 shown in FIG. 1;

FIG. 6 is a circuit diagram showing an example of a configuration of the VDC generation circuit (voltage stepdown circuit) 6 shown in FIG. 1;

FIG. 7 is a circuit diagram showing an example of a configuration of the VAA generation circuit (voltage stepdown circuit) 7 shown in FIG. 1;

FIG. 8 is a circuit diagram showing an example of a configuration of the VINT generation circuit (voltage stepdown circuit) 8 shown in FIG. 1;

FIG. 9 is a timing chart showing an example of signal waveforms of components in the memory system 1000;

FIG. 10 is a diagram showing an example of a connection relation between outputs of the VPP_{Low} generation circuit 4 and the VPP_{High} generation circuit 5 for supplying the voltages more efficiently in the internal power supply voltage generation circuit 100 shown in FIG. 1;

FIG. 11 is a circuit diagram showing another example of the configuration of the VDC generation circuit (voltage stepdown circuit) 6 shown in FIG. 1;

FIG. 12 is a circuit diagram showing another example of the configuration of the VAA generation circuit (voltage stepdown circuit) 7 shown in FIG. 1;

FIG. 13 is a circuit diagram showing another example of the configuration of the VINT generation circuit (voltage stepdown circuit) 8 shown in FIG. 1;

FIG. 14 is a diagram showing an example of a configuration of a reference potential generation circuit applied to the band gap reference (BGR) circuit and the reference potential generation circuit showing in FIG. 1;

FIG. 15 is a timing chart showing an example of signal waveforms of various components in the memory system 1000;

FIG. 16 is a block diagram showing an example of a memory system 4000 including an internal power supply voltage generation circuit 400 according to the fourth embodiment which is a mode of the present invention;

FIG. 17 is a circuit diagram showing an example of a configuration of the VPP_{Low} generation circuit (charge pump circuit) 4 shown in FIG. 16;

FIG. 18 is a circuit diagram showing an example of a configuration of the VPP_{High} generation circuit (charge pump circuit) 5 shown in FIG. 16;

FIG. 19 is a circuit diagram showing an example of a configuration of the VDC generation circuit (voltage stepdown circuit) 6 shown in FIG. 16;

FIG. 20 is a circuit diagram showing an example of a configuration of the VAA generation circuit (voltage stepdown circuit) 7 shown in FIG. 16;

FIG. 21 is a timing chart showing an example of signal waveforms of various components in the memory system 4000;

FIG. 22 is a circuit diagram showing an example of a ferroelectric memory apparatus having a TC unit type memory cell array configuration according to the fifth embodiment of the present invention;

FIG. 23 is a block diagram showing an example of a memory system 5000 including an internal power supply voltage generation circuit 500 according to the fifth embodiment which is a mode of the present invention;

FIG. 24 is a timing chart showing an example of signal waveforms of various components in the memory system 5000;

FIG. 25 is a circuit diagram showing an example of a ferroelectric memory apparatus according to the sixth embodiment of the present invention;

FIG. 26 is a block diagram showing an example of a memory system 6000 including an internal power supply voltage generation circuit 600 according to the sixth embodiment which is a mode of the present invention; and

FIG. 27 is a timing chart showing an example of signal waveforms of various components in the memory system 6000.

### DETAILED DESCRIPTION

Hereafter, an internal power supply voltage generation circuit according to the present invention will be described more specifically with reference to the drawings.

In the internal power supply voltage generation circuit according to the present invention, a stepped up voltage VPP_{High} and a stepped up voltage VPP_{Low} are generated by a two-stage charge pump circuit.

And, for example, if the relation VDD<V1<VPP_{Low}<VPP_{High} holds true with respect to a certain internal power supply voltage V1, the internal power voltage generation circuit generates the internal power supply voltage (stepped down voltage) V1 by using the stepped up voltage VPP_{Low} as a power supply.

On the other hand, if the relation VDD<VPP_{Low}<V2<VPP_{High} holds true with respect to a certain internal power supply voltage V2, the internal power voltage generation circuit generates the internal power supply voltage (stepped down voltage) V2 by using the stepped up voltage VPP_{High} as a power supply.

Hereafter, embodiments of the present invention will be described with reference to the drawings.

The ensuing embodiments will be described by taking the case where the semiconductor memory (memory system) is a NAND flash memory as an example. However, the embodiments can also be applied to other LSI circuits such as semiconductor memories of which low voltage operation is required, in the same way.

### First Embodiment

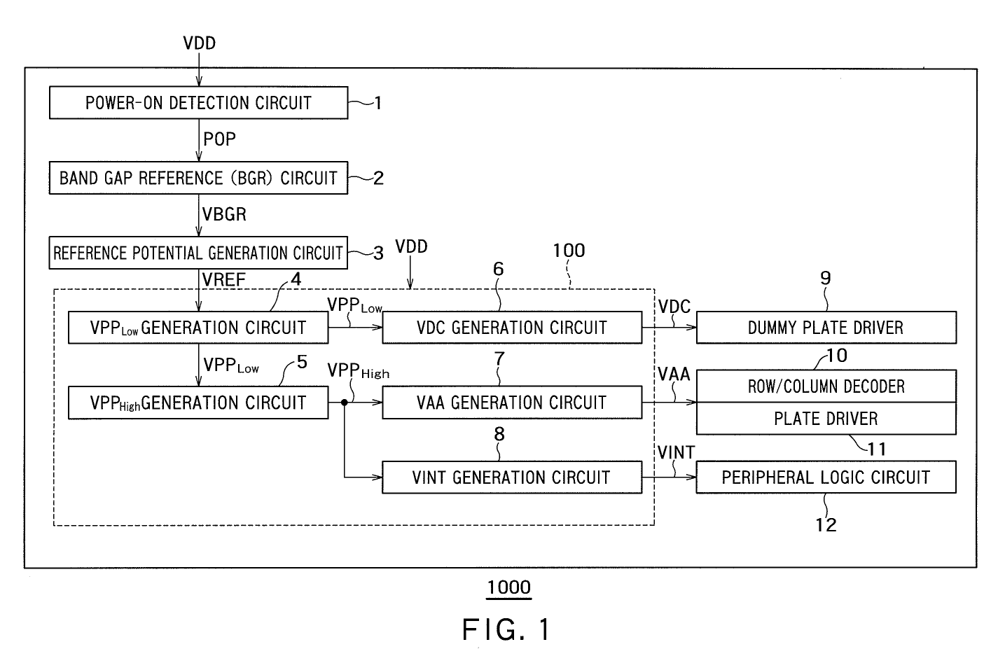

FIG. 1 is a block diagram showing an example of a memory system 1000 including an internal power supply voltage generation circuit 100 according to a first embodiment which is a mode of the present invention.

As shown in FIG. 1, the memory system 1000 includes a power-on detection circuit 1, a band gap reference (BGR) circuit 2, a reference potential generation circuit 3, a VPP_{Low} generation circuit (charge pump circuit) 4, a VPP_{High} generation circuit (charge pump circuit) 5, a VDC generation circuit (voltage stepdown circuit) 6, a VAA generation circuit (voltage stepdown circuit) 7, a VINT generation circuit (voltage stepdown circuit) 8, a dummy plate driver 9, a row/column decoder 10, a plate driver 11, and a peripheral logic circuit 12.

The internal power supply voltage generation circuit 100 includes the VPP_{Low} generation circuit (charge pump circuit) 4, the VPP_{High} generation circuit (charge pump circuit) 5, the VDC generation circuit (voltage stepdown circuit) 6, the VAA generation circuit (voltage stepdown circuit) 7, and the VINT generation circuit (voltage stepdown circuit) 8 out of the above components.

The power-on detection circuit 1 is adapted to detect that the external power supply voltage has become at least a certain value, and output a power-on signal POP according to a result of the detection.

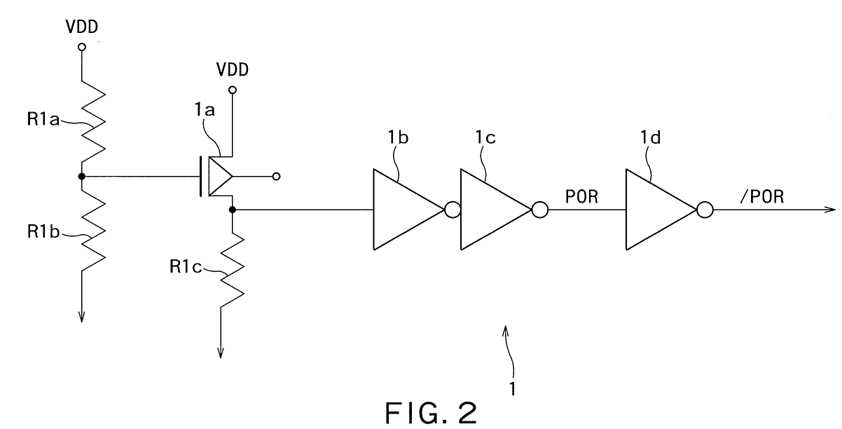

FIG. 2 is a circuit diagram showing an example of a configuration of the power-on detection circuit 1 shown in FIG. 1.

As shown in FIG. 2, the power-on detection circuit 1 includes resistors R1a and R1b which divide the external power supply voltage VDD, an nMOS transistor 1a supplied at its gate with a voltage obtained by the voltage division and connected between the power supply and ground in series with a resistor R1c, and inverters 1b to 1d supplied with a potential at a drain of the pMOS transistor 1a and connected in series.

The power-on detection circuit 1 is adapted to detect that the external power supply voltage VDD has become at least a certain value, and output power-on signals POP and /POP from the inverters 1c and 1d, respectively.

As shown in FIG. 1, the band gap reference circuit 2 generates a band gap reference potential VBGR on the basis of the external power supply voltage VDD, and the reference potential generation circuit 3 generates a reference voltage VREF on the basis of the band gap reference potential VBGR

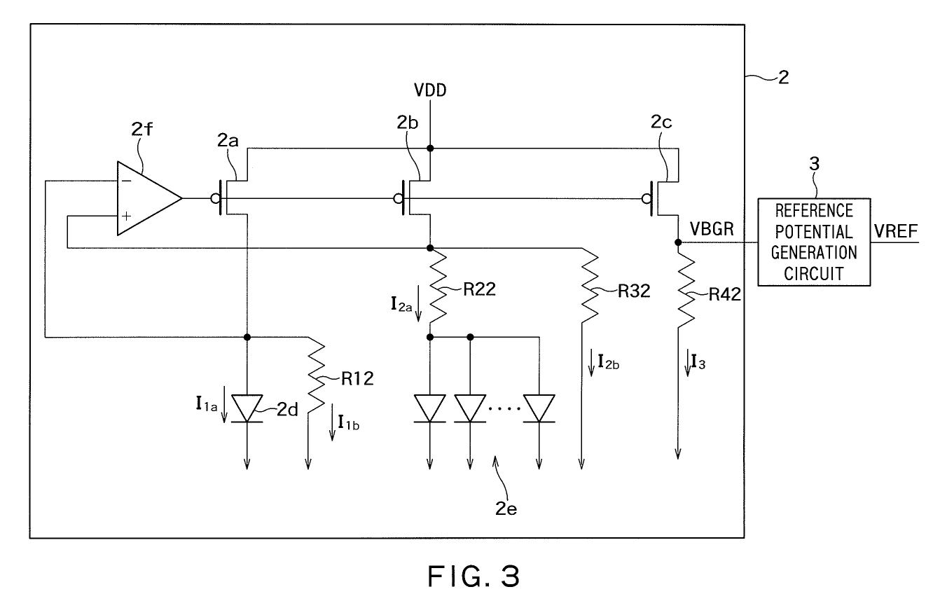

FIG. 3 is a diagram showing an example of a configuration of the band gap reference circuit 2 and the reference potential generation circuit 3.

As shown in FIG. 3, the band gap reference circuit 2 and the reference potential generation circuit 3 are circuits which generate the reference voltage VREF for generating internal power supply voltages.

The band gap reference generation circuit 2, which is a principal part, includes pMOS transistors 2a to 2c, a resistor R12 through which a current I_{1b} flows, a resistor R22 through which a current I₁ₐ flows, a resistor R32 through which a current I_{2b} flows, a resistor R42 through which a current I₃ flows, a diode 2d through which a current I₁ₐ flows, n diodes 2e, and an amplifier circuit 2f.

As shown in FIG. 1, the VPP_{Low} generation circuit 4 is adapted to step up the external power supply voltage VDD and output the stepped up voltage VPP_{Low}. The VPP_{High} generation circuit 5 is adapted to step up the stepped up voltage VPP_{Low} and output the stepped up voltage VPP_{High} which is higher than the stepped up voltage VPP_{Low}.

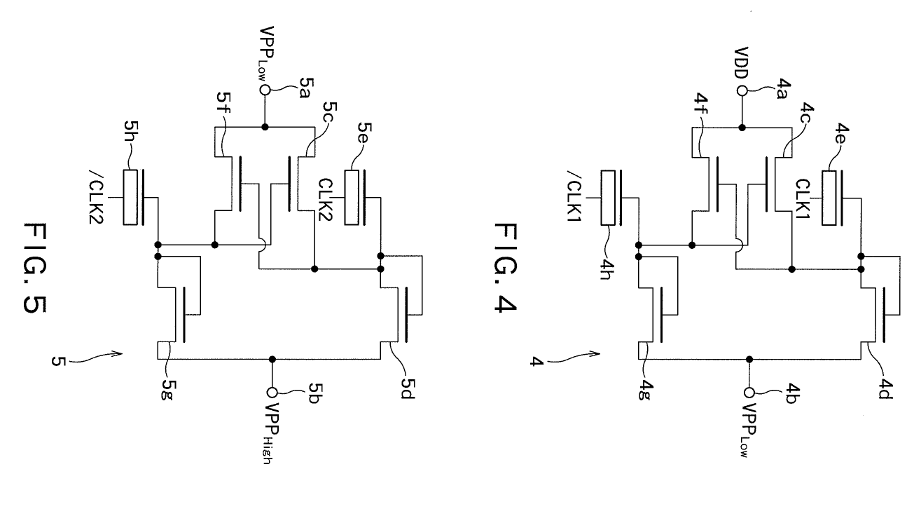

FIG. 4 is a circuit diagram showing an example of a configuration of the VPP_{Low} generation circuit (charge pump circuit) 4 shown in FIG. 1. FIG. 5 is a circuit diagram showing an example of a configuration of the VPP_{High} generation circuit (charge pump circuit) 5 shown in FIG. 1. The case where nMOS transistors are used will now be described with reference to FIGS. 4 and 5. However, the circuits may be formed of pMOS transistors to conduct similar operations.

As shown in FIG. 4, the VPP_{Low} generation circuit 4, which is the charge pump circuit, includes an nMOS transistor 4c connected at its drain to a voltage stepup input terminal 4a, which is supplied with the external power supply voltage VDD, an nMOS transistor 4d connected at its drain and gate to the nMOS transistor 4c at its source and connected at its source to a voltage stepup output terminal 4b, and a MOS capacitor 4e connected at its gate to the source of the nMOS transistor 4c and supplied at its source and drain with a first clock signal CLK1.

The VPP_{Low} generation circuit 4 further includes an nMOS transistor 4f connected at its drain to the voltage stepup input terminal 4a, connected at its source to the nMOS transistor 4c at its gate, and connected at its gate to the source of the nMOS transistor 4c, an nMOS transistor 4g connected at its drain and gate to the source of the nMOS transistor 4f and connected at its source to the voltage stepup output terminal 4b, and a MOS capacitor 4h connected at its gate to the source of the nMOS transistor 4f and supplied at its source and drain with a signal/CLK1 obtained by inverting the phase of the first clock signal CLK1.

The VPP_{Low} generation circuit 4 is adapted to step up the external power supply voltage VDD and output the stepped up voltage VPP_{Low} from the voltage stepup output terminal 4b in accordance with the first clock signal CLK1 and the signal /CLK1.

As shown in FIG. 5, the VPP_{High} generation circuit 5, which is the charge pump circuit, includes an nMOS transistor 5c connected at its drain to a voltage stepup input terminal 5a, which is supplied with the stepped up voltage VPP_{Low}, an nMOS transistor 5d connected at its drain and gate to the nMOS transistor 5c at its source and connected at its source to a voltage stepup output terminal 5b, and a second MOS capacitor 5e connected at its gate to the source of the nMOS transistor 5c and supplied at its source and drain with a second clock signal CLK2.

The VPP_{High} generation circuit 5 further includes an nMOS transistor 5f connected at its drain to the voltage stepup input terminal 5a, connected at its source to the nMOS transistor 5c at its gate, and connected at its gate to the source of the nMOS transistor 5c, an nMOS transistor 5g connected at its drain and gate to the source of the nMOS transistor 5f and connected at its source to the voltage stepup output terminal 5b, and a MOS capacitor 5h connected at its gate to the source of the nMOS transistor 5f and supplied at its source and drain with a signal/CLK2 obtained by inverting the phase of the second clock signal CLK2.

The VPP_{High} generation circuit 5 is adapted to step up the stepped up voltage VPP_{Low} and output the stepped up voltage VPP_{High}, which is higher than the stepped up voltage VPP_{Low}, from the voltage stepup output terminal 5b in accordance with the second clock signal CLK2 and the signal /CLK2.

As shown in FIG. 1, the VDC generation circuit 6, which is the voltage stepdown circuit, is adapted to step down the stepped up voltage VPP_{Low}, generate a stepped down voltage VDC, which is an internal power supply voltage, and supply the stepped down voltage VDC to the dummy plate driver 9.

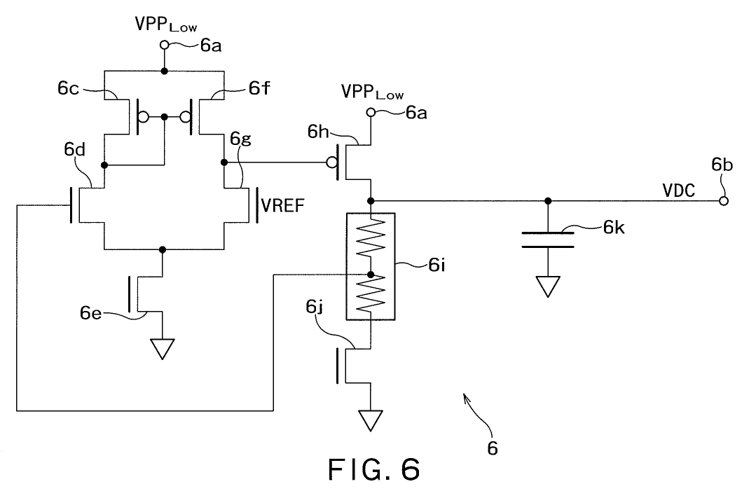

FIG. 6 is a circuit diagram showing an example of a configuration of the VDC generation circuit (voltage stepdown circuit) 6 shown in FIG. 1.

As shown in FIG. 6, the VDC generation circuit 6, which is the voltage stepdown circuit, includes a pMOS transistor 6c connected at its source to a voltage stepdown input terminal 6a, which is supplied with the stepped up voltage VPP_{Low}, and diode-connected, an nMOS transistor 6d connected at its drain to the pMOS transistor 6c at its drain, an nMOS transistor 6e connected between a source of the nMOS transistor 6d and the ground and supplied at its gate with a predetermined voltage, a pMOS transistor 6f connected at its source to the voltage stepdown input terminal 6a and connected to the pMOS transistor 6c at their gates, and an nMOS transistor 6g connected to the pMOS transistor 6f at their drains, connected at its source to the source of the nMOS transistor 6d, and supplied at its gate with the reference voltage VREF.

The VDC generation circuit 6 further includes a pMOS transistor 6h connected at its source to the voltage stepdown input terminal 6a, which is supplied with the stepped up voltage VPP_{Low}, connected at its gate to the drain of the pMOS transistor 6f, and connected at its drain to a voltage stepdown output terminal 6b, from which the stepped down voltage VDC is output, a voltage division circuit 6i connected at its first end to the drain of the pMOS transistor 6h to output a voltage obtained by dividing the stepped up voltage VPP_{Low} to the gate of the nMOS transistor 6d, an nMOS transistor 6j connected between a second end of the voltage division circuit 6i and the ground and supplied at its gate with a predetermined voltage, and a capacitor 6k connected between the voltage stepdown output terminal 6b and the ground.

As shown in FIG. 6, a circuit scheme called PMOS-Feed-Back type is adopted in the VDC generation circuit 6.

The VDC generation circuit 6 is adapted to generate the internal power supply voltage VDC, which is the stepped down voltage, by stepping down the stepped up voltage VPP_{Low} applied to the voltage stepdown input terminal 6a, and output the internal power supply voltage VDC to the voltage stepdown output terminal 6b.

As shown in FIG. 1, a VAA generation circuit 7, which is the voltage stepdown circuit, is adapted to step down the stepped up voltage VPP_{High}, generate a stepped down voltage VAA, which is an array voltage for supplying a potential to a memory cell array (not illustrated), and supply the stepped down voltage VAA to the row/column decoder 10 and the plate driver 11.

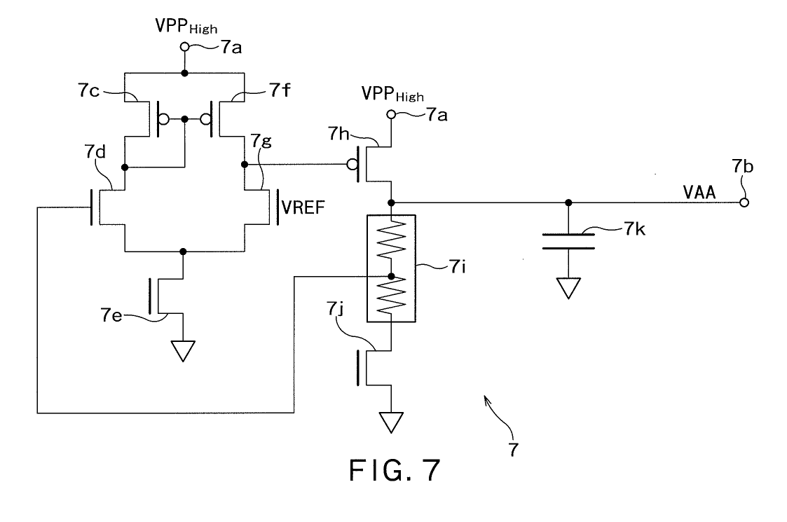

FIG. 7 is a circuit diagram showing an example of a configuration of the VAA generation circuit (voltage stepdown circuit) 7 shown in FIG. 1.

As shown in FIG. 7, the VAA generation circuit 7, which is the voltage stepdown circuit, includes a pMOS transistor 7c connected at its source to a voltage stepdown input terminal 7a, which is supplied with the stepped up voltage VPP_{High}, and diode-connected, an nMOS transistor 7d connected to the pMOS transistor 7c at their drains, an nMOS transistor 7e connected between a source of the nMOS transistor 7d and the ground and supplied at its gate with a predetermined voltage, a pMOS transistor 7f connected at its source to the voltage stepdown input terminal 7a and connected to the pMOS transistor 7c at their gates, and an nMOS transistor 7g connected to the nMOS transistor 7f at their drains, connected at its source to the source of the nMOS transistor 7d, and supplied at its gate with the reference voltage VREF.

The VAA generation circuit 7 further includes a pMOS transistor 7h connected at its source to the voltage stepdown input terminal 7a, which is supplied with the stepped up voltage VPP_{High}, connected at its gate to the pMOS transistor 7f at its drain, and connected at its drain to a voltage stepdown output terminal 7b, which outputs the internal stepped down voltage VAA, a voltage division circuit 7i connected at its first end to the drain of the pMOS transistor 7h to output a voltage obtained by dividing the stepped up voltage VPP_{High} to a gate of the nMOS transistor 7d, an nMOS transistor 7j connected between a second end of the voltage division circuit 7i and the ground and supplied at its gate with a predetermined voltage, and a capacitor 7k connected between a voltage stepdown output terminal 7b and the ground.

As shown in FIG. 7, the circuit scheme called PMOS-Feed-Back type is adopted in the VAA generation circuit as well.

The VAA generation circuit 7 is adapted to generate the stepped down voltage VAA by stepping down the stepped up voltage VPP_{High} applied to the voltage stepdown input terminal 7a and output the stepped down voltage VAA to the voltage stepdown output terminal 7b.

As shown in FIG. 1, a VINT generation circuit 8 is adapted to step down the stepped up voltage VPP_{High} and generate an internal power supply voltage VINT for driving the peripheral logic circuit 12 and the like.

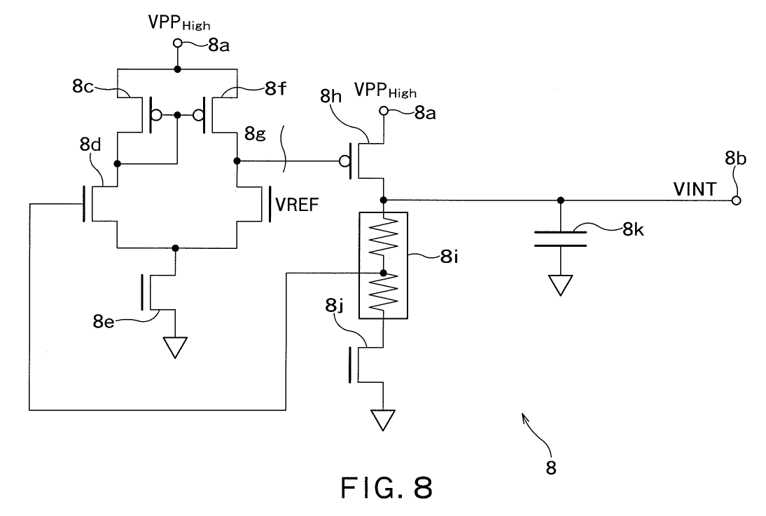

FIG. 8 is a circuit diagram showing an example of a configuration of the VINT generation circuit (voltage stepdown circuit) 8 shown in FIG. 1.

As shown in FIG. 8, the VINT generation circuit 8, which is the voltage stepdown circuit, includes a pMOS transistor 8c connected at its source to a voltage stepdown input terminal 8a, which is supplied with the stepped up voltage VPP_{High}, and diode-connected, an nMOS transistor 8d connected to the pMOS transistor 8c connected at their drains, an nMOS transistor 8e connected between a source of the nMOS transistor 8d and the ground, and supplied at its gate with a predetermined voltage, a pMOS transistor 8f connected at its source to the voltage stepdown input terminal 8a and connected to the pMOS transistor 8c at their gates, and an nMOS transistor 8g connected to the pMOS transistor 8f at their drains, connected at its source to the source of the nMOS transistor 8d and supplied at its gate with the reference voltage VREF.

The VINT generation circuit 8 further includes a pMOS transistor 8h connected at its source to the stepdown input terminal 8a, which is supplied with the stepped up voltage VPP_{High}, connected at its gate to the drain of the pMOS transistor 8f, connected at its drain to a voltage stepdown output terminal 8b, from which the internal power supply voltage VINT is output, a voltage division circuit 8i connected at its first end to the drain of the pMOS transistor 8h to output a voltage obtained by dividing the stepped up voltage VPP_{High} to a gate of the nMOS transistor 8d, an nMOS transistor 8j connected between a second end of the voltage division circuit 8i and the ground and supplied at its gate with a predetermined voltage, and a capacitor 8k connected between the voltage stepdown output terminal 8b and the ground.

As shown in FIG. 8, the circuit scheme called PMOS-Feed-Back type is adopted in the VINT generation circuit.

The VINT generation circuit 8 is adapted to generate the internal power supply voltage VINT, which is the stepped down voltage, by stepping down the stepped up voltage VPP_{High}, which is applied to the voltage stepdown input terminal 8a, and output the internal power supply voltage VINT to the voltage stepdown output terminal 8b.

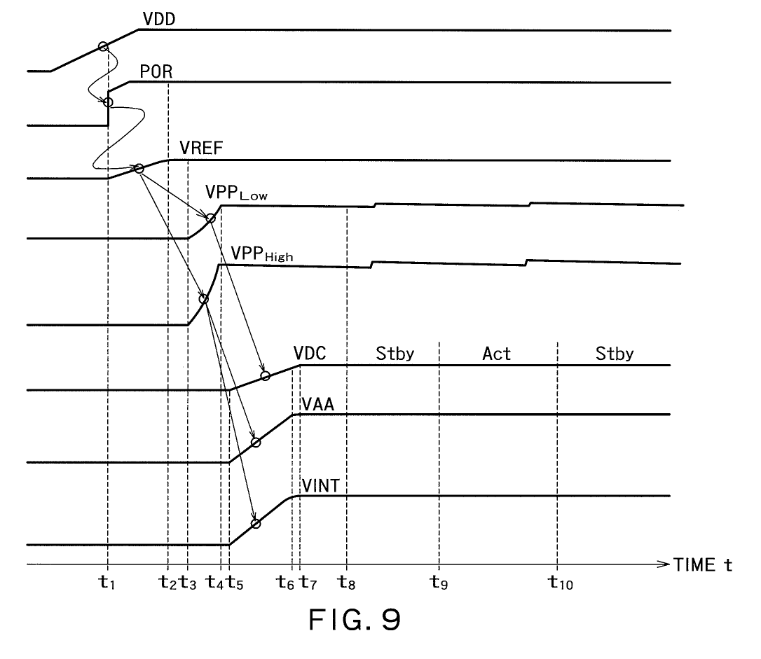

An example of operation of the memory system 1000 having a configuration described heretofore will now be described. FIG. 9 is a timing chart showing an example of signal waveforms of components in the memory system 1000.

If the external power supply voltage VDD rises, the power-on detection circuit 1 detects that the external power supply voltage VDD has become a predetermined voltage at time t1, and generates a power-on signal POR.

In response to the power-on signal POR, the band gap reference circuit 2 and the reference potential generation circuit 3 generate the reference voltage VREF to supply to the internal power supply voltage generation circuit 100 (time t2).

Subsequently, the VPP_{Low} generation circuit 4 and the VPP_{High} generation circuit 5 are started (time t3). The VPP_{Low} generation circuit 4 and the VPP_{High} generation circuit 5 generate the predetermined stepped up voltage VPP_{Low} and stepped up voltage VPP_{High}, respectively (time t4).

Then, the VAA generation circuit 7, the VINT generation circuit 8, and the VDC generation circuit 6 are started (time t5).

Then, the VAA generation circuit 7 and the VINT generation circuit 8 step down the stepped up voltage VPP_{High} by using it as a power supply voltage, and generate a stepped down voltage (internal power supply voltage) VINT and a stepped down voltage (array voltage) VAA, respectively (time t6).

Then, the VDC generation circuit 6 steps down the stepped up voltage VPP_{Low} by using it as a power supply voltage, and generates a stepped down voltage (internal power supply voltage) VDC (time t7).

Then, for example, before time t9 and after time t10 (Stby), the VAA generation circuit 7, the VINT generation circuit 8 and the VDC generation circuit 6, which are designed to be less in current consumption, but be low in reactivity, conduct voltage stepdown operation. On the other hand, between time t9 and t10, the VAA generation circuit 7, the VINT generation circuit 8 and the VDC generation circuit 6, which are designed to be greater in current consumption, but be high in reactivity, conduct voltage stepdown operation.

In the conventional art, the stepped down voltages such as VINT, VAA and VDC are generated by stepping down the external power supply voltage VDD as already described.

If, for example, conditions represented by the following Expressions (1) to (3) are satisfied, however, it is impossible to generate VINT, VAA and VDC by using the external power supply voltage VDD as a power supply voltage. In the present embodiment, therefore, various internal power supply voltages (stepped down voltages) are generated by stepping up the external power supply voltage VDD once to generate the stepped up voltage VPP_{Low} and the stepped up voltage VPP_{High}, and then stepping down them. In Expressions (1) to (3), VINTₘₐₓ represents a maximum value of VINT, VAAₘₐₓ represents a maximum value of VAA, and VDCₘₐₓ represents a maximum value of VDC.

VDD<VINTₘₐₓ (1)

VDD<VAAₘₐₓ (2)

VDD<VDCₘₐₓ (3)

In the present embodiment, the stepped down voltage VINT and the stepped down voltage VAA are generated by stepping down the stepped up voltage VPP_{High} and the stepped down voltage VDC is generated by stepping down the stepped up voltage VPP_{Low}, by utilizing the fact that conditions represented by the following Expressions (4) to (6) are satisfied.

VPP_{Low}<VINTₘₐₓ<VPP_{High} (4)

VPP_{Low}<VAAₘₐₓ<VPP_{High} (5)

VDCₘₐₓ<VPP_{Low} (6)

For example, for generating charge of the stepped up voltage VPP_{High}, as much charge of the external power supply voltage VDD as approximately three times is needed. In this case, for generating charge of the stepped up voltage VPP_{Low}, as much charge of the external power supply voltage VDD as approximately twice is needed.

If a condition represented by the following Expression (7) is satisfied, it is more efficient to generate the stepped down voltage VDC by stepping down the stepped up voltage VPP_{Low} as compared with the case where all of VINT, VAA and VDC are generated from VPP_{High} as in the conventional art.

VDCₘₐₓ<VPP_{Low} (7)

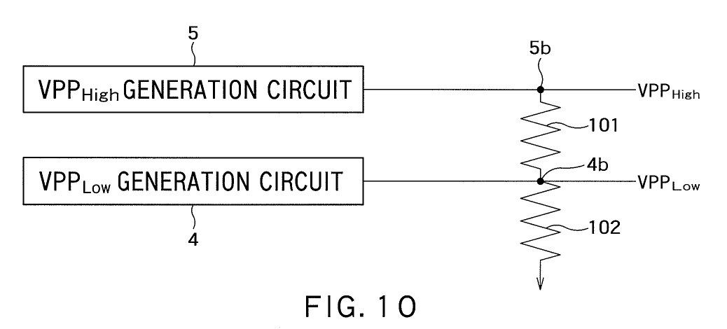

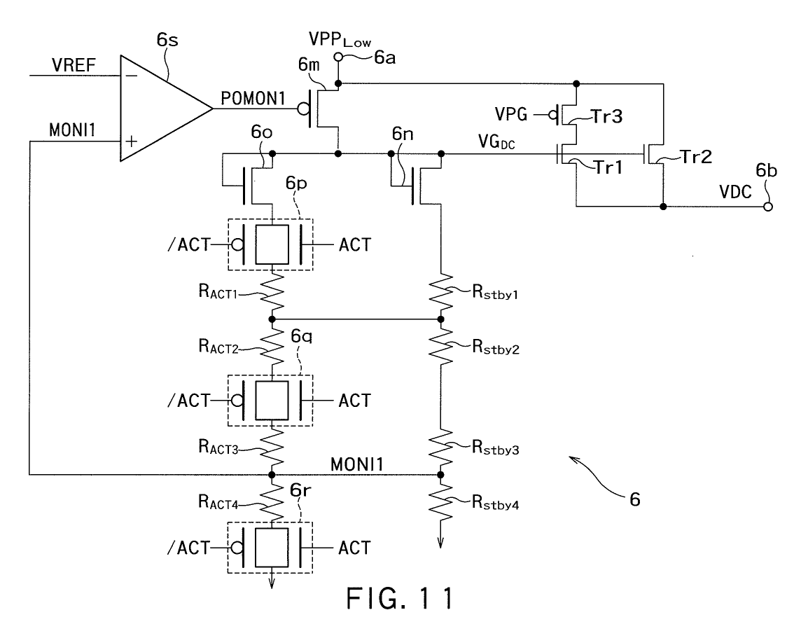

FIG. 10 is a diagram showing an example of a connection relation between outputs of the VPP_{Low} generation circuit 4 and the VPP_{High} generation circuit 5 for supplying the voltages more efficiently in the internal power supply voltage generation circuit 100 shown in FIG. 1.

As shown in FIG. 10, the internal power supply voltage generation circuit 100 includes an output resistor 101 connected between the voltage stepup output terminal 4b and the voltage stepup output terminal 5b, and an output resistor 102 connected between the voltage stepup output terminal 4b and the ground.

After elapse of a period of time since the VPP_{Low} generation circuit 4 and the VPP_{High} generation circuit 5 are caused to conduct the voltage stepup operation (for example, at time t8 in FIG. 9), the internal power supply voltage generation circuit 100 inactivates the VPP_{Low} generation circuit 4 while causing the VPP_{High} generation circuit 5 to conduct the voltage stepup operation.

In the connection relation, the VPP_{High} generation circuit 5 continuously conducts the voltage stepup operation, and consequently the voltage at the voltage stepup output terminal 4b is kept at a desired stepped up voltage VPP_{Low}. And the current consumption can be reduced by inactivating the VPP_{Low} generation circuit 4. In other words, the current consumption can be reduced while maintaining the desired stepped up voltage.

According to the internal power supply voltage generation circuit in the present embodiment, voltages can be supplied more efficiently as heretofore described.

### Second Embodiment

In the first embodiment, an example of a configuration such that a circuit scheme called PMOS-Feed-Back type is adopted in the circuit configuration of the voltage stepdown circuits in the memory system has been described.

In a second embodiment, an example in which a scheme called voltage stepdown transistor (giant transistor) is adopted in the circuit configuration of the voltage stepdown circuits in the memory system will be described. The memory system in the present second embodiment has a configuration similar to that of the memory system 1000 in the first embodiment shown in FIG. 1. Furthermore, since operation of the memory system 1000 in the present second embodiment is similar to that in the first embodiment, signal waveforms become similar to those in the first embodiment shown in FIG. 9.

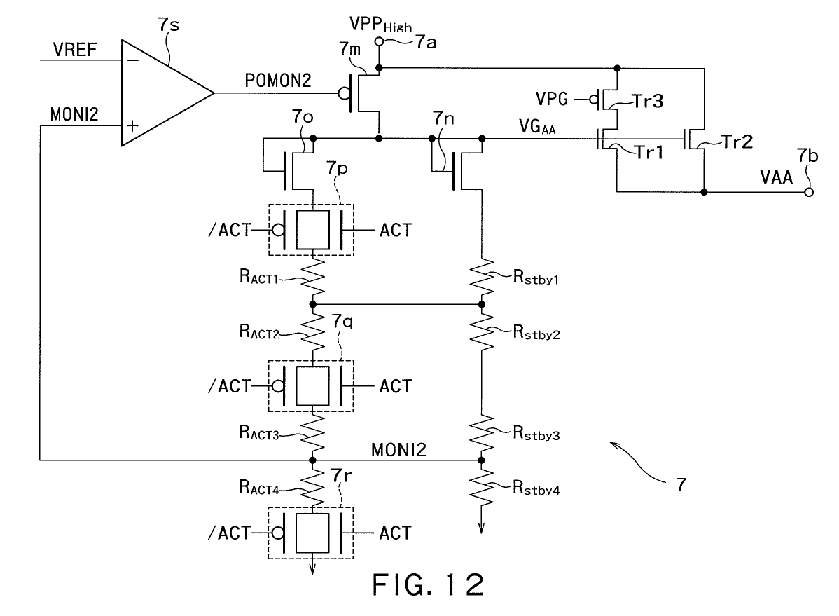

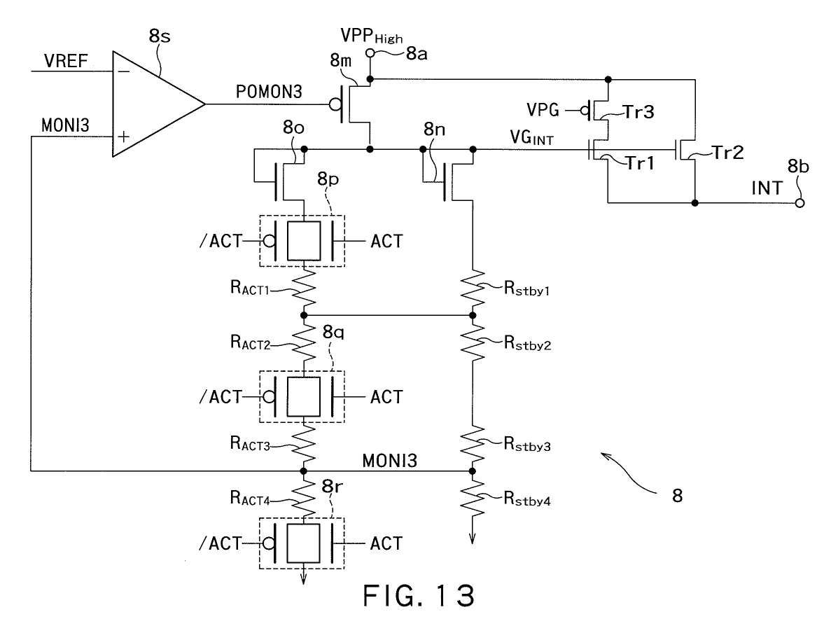

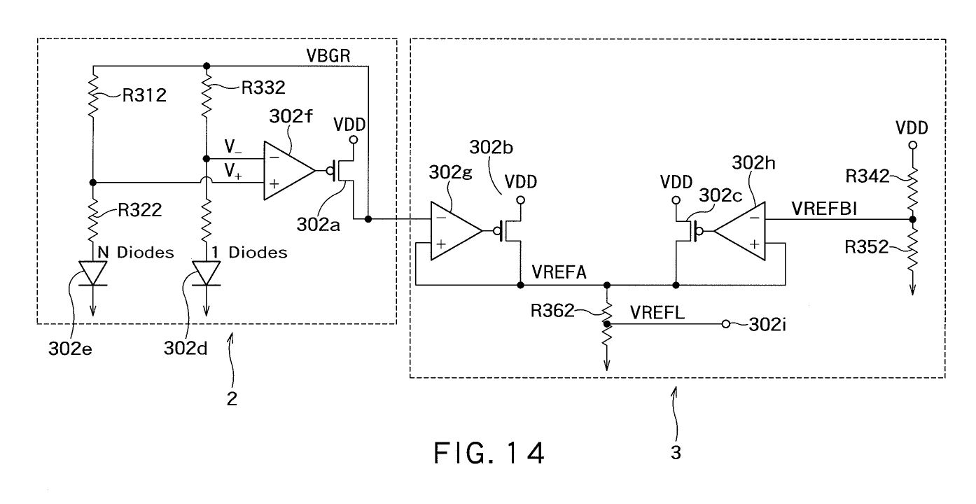

FIG. 11 is a circuit diagram showing another example of the configuration of the VDC generation circuit (voltage stepdown circuit) 6 shown in FIG. 1. FIG. 12 is a circuit diagram showing another example of the configuration of the VAA generation circuit (voltage stepdown circuit) 7 shown in FIG. 1. FIG. 13 is a circuit diagram showing another example of the configuration of the VINT generation circuit (voltage stepdown circuit) 8 shown in FIG. 1.

As shown in FIG. 11, the VDC generation circuit 6, which is the voltage stepdown circuit, includes an nMOS transistor Tr1 connected between a voltage stepdown input terminal 6a supplied with the stepped up voltage VPP_{Low} and a voltage stepdown output terminal 6b, an nMOS transistor Tr2 connected between the voltage stepdown input terminal 6a and the voltage stepdown output terminal 6b and connected to the nMOS transistor Tr1 at their gates, and a pMOS transistor Tr3 connected between the voltage stepdown input terminal 6a and the nMOS transistor Tr1 and supplied with a predetermined voltage VPG at its gate. A gate voltage VG_{DC} of the nMOS transistors Tr1 and Tr2 is set to be higher than the external power supply voltage VDD and lower than the stepped up voltage VPP_{Low}.

The VDC generation circuit 6 further includes a pMOS transistor 6m connected at its source to the voltage stepdown input terminal 6a and connected at its drain to the gate of the nMOS transistor Tr1, an nMOS transistor 6n connected at its drain and gate to the drain of the pMOS transistor 6m, a voltage dividing resistor R_{stby1} connected at its first end to the nMOS transistor 6n at its source, a voltage dividing resistor R_{stby2} connected at its first end to a second end of the voltage dividing resistor R_{stby1}, a voltage dividing resistor R_{stby3} connected at its first end to a second end of the voltage dividing resistor R_{stby2}, and a voltage dividing resistor R_{stby4} connected between a second end of the voltage dividing resistor R_{stby3} and the ground.

The VDC generation circuit 6 further includes an nMOS transistor 6o connected at its drain and gate to the drain of the pMOS transistor 6m, a switch circuit 6p which is connected at its first end to the nMOS transistor 6o at its source and which turns on in accordance with activation signals ACT and /ACT, a voltage dividing resistor R_{ACT1} connected at its first end to a second end of the switch circuit 6p, a voltage dividing resistor R_{ACT2} connected at its first end to a second end of the voltage dividing resistor R_{ACT1} and the second end of the voltage dividing resistor R_{stby1}, a switch circuit 6q which is connected at its first end to a second end of the voltage dividing resistor R_{ACT2} and which turns on in accordance with the activation signals ACT and /ACT, a voltage dividing resistor R_{ACT3} connected at its first end to a second end of the switch circuit 6q, a voltage dividing resistor R_{ACT4} connected at its first end to a second end of the voltage dividing resistor R_{ACT3} and the second end of the voltage dividing resistor R_{stby3}, a switch circuit 6r which is connected between a second end of the voltage dividing resistor R_{ACT4} and the ground and which turns on in accordance with the activation signals ACT and /ACT, and an amplifier circuit 6s which compares a monitor voltage MONI1 between the voltage dividing resistor R_{stby3} and the voltage dividing resistor R_{stby4} with the reference voltage VREF and which outputs a voltage PGMONI1 depending upon a result of the comparison to a gate of the pMOS transistor 6m.

As shown in FIG. 11, each of the switch circuits 6p, 6q and 6r includes an nMOS transistor supplied at its gate with the activation signal ACT and a pMOS transistor supplied at its gate with activation signals /ACT obtained by inverting the activation signal ACT and connected in parallel with the nMOS transistor.

The VDC generation circuit 6 is adapted to step down the stepped up voltage VPP_{Low} and output a stepped down voltage VDC from the voltage stepdown output terminal 6b.

For example, before time t9 and from time t10 (Stby) already described and shown in FIG. 9, the switch circuits 6p, 6q and 6r turn off in accordance with the activation signals ACT and /ACT. As a result, the VDC generation circuit 6 is set to be less in current consumption but low in reactivity. On the other hand, between time t9 and t10 (ACT), the switch circuits 6p, 6q and 6r turn on in accordance with the activation signals ACT and /ACT. As a result, the VDC generation circuit 6 is set to be great in current consumption but high in reactivity.

As shown in FIG. 12, the VAA generation circuit 7, which is the voltage stepdown circuit, includes an nMOS transistor Tr1 connected between a voltage stepdown input terminal 7a supplied with the stepped up voltage VPP_{High} and a voltage stepdown output terminal 7b, an nMOS transistor Tr2 connected between the voltage stepdown input terminal 7a and the voltage stepdown output terminal 7b and connected to the nMOS transistor Tr1 at their gates, and a pMOS transistor Tr3 connected between the voltage stepdown input terminal 7a and the nMOS transistor Tr1 and supplied with the predetermined voltage VPG at its gate. A gate voltage VG_{AA} of the nMOS transistors Tr1 and Tr2 is set to be higher than the external power supply voltage VDD and lower than the stepped up voltage VPP_{High}.

The VAA generation circuit 7 further includes a pMOS transistor 7m connected at its source to the voltage stepdown input terminal 7a and connected at its drain to the gate of the nMOS transistor Tr1, an nMOS transistor 7n connected at its drain and gate to the drain of the pMOS transistor 7m, a voltage dividing resistor R_{stby1} connected at its first end to the nMOS transistor 7n at its source, a voltage dividing resistor R_{stby2} connected at its first end to a second end of the voltage dividing resistor R_{stby1}, a voltage dividing resistor R_{stby3} connected at its first end to a second end of the voltage dividing resistor R_{stby2}, and a voltage dividing resistor R_{stby4} connected between a second end of the voltage dividing resistor R_{stby3} and the ground.

The VAA generation circuit 7 further includes an nMOS transistor 7o connected at its drain and gate to the drain of the pMOS transistor 7m, a switch circuit 7p which is connected at its first end to the nMOS transistor 7o at its source and which turns on in accordance with activation signals ACT and /ACT, a voltage dividing resistor R_{ACT1} connected at its first end to a second end of the switch circuit 7p, a voltage dividing resistor R_{ACT2} connected at its first end to a second end of the voltage dividing resistor R_{ACT1} and the second end of the voltage dividing resistor R_{stby1}, a switch circuit 7q which is connected at its first end to a second end of the voltage dividing resistor R_{ACT2} and which turns on in accordance with the activation signals ACT and /ACT, a voltage dividing resistor R_{ACT3} connected at its first end to a second end of the switch circuit 7q, a voltage dividing resistor R_{ACT4} connected at its first end to a second end of the voltage dividing resistor R_{ACT3} and the second end of the voltage dividing resistor R_{stby3}, a switch circuit 7r which is connected between a second end of the voltage dividing resistor R_{ACT4} and the ground and which turns on in accordance with the activation signals ACT and /ACT, and an amplifier circuit 7s which compares a monitor voltage MONI2 between the voltage dividing resistor R_{stby3} and the voltage dividing resistor R_{stby4} with the reference voltage VREF and which outputs a voltage PGMONI2 depending upon a result of the comparison to a gate of the pMOS transistor 7m.

As shown in FIG. 12, each of the switch circuits 7p, 7q and 7r includes an nMOS transistor supplied at its gate with the activation signal ACT and a pMOS transistor supplied at its gate with the activation signal /ACT obtained by inverting the activation signal ACT and connected in parallel with the nMOS transistor.

The VAA generation circuit 7 is adapted to step down the stepped up voltage VPP_{High} and output a stepped down voltage VAA from the voltage stepdown output terminal 7b.

For example, before time t9 and after time t10 (Stby) already described and shown in FIG. 9, the switch circuits 7p, 7q and 7r turn off in accordance with the activation signals ACT and /ACT. As a result, the VAA generation circuit 7 is set to be less in current consumption but low in reactivity. On the other hand, between time t9 and t10 (ACT), the switch circuits 7p, 7q and 7r turn on in accordance with the activation signals ACT and /ACT. As a result, the VAA generation circuit 7 is set to be great in current consumption but high in reactivity.

As shown in FIG. 13, the VINT generation circuit 8, which is the voltage stepdown circuit, includes an nMOS transistor Tr1 connected between a voltage stepdown input terminal 8a supplied with the stepped up voltage VPP_{High} and a voltage stepdown output terminal 8b, an nMOS transistor Tr2 connected between the voltage stepdown input terminal 8a and the voltage stepdown output terminal 8b and connected to the nMOS transistor Tr1 at their gates, and a pMOS transistor Tr3 connected between the voltage stepdown input terminal 8a and the nMOS transistor Tr1 and supplied with the predetermined voltage VPG at its gate. A gate voltage VG_{INT} of the nMOS transistors Tr1 and Tr2 is set to be higher than the external power supply voltage VDD and lower than the stepped up voltage VPP_{High}.

The VINT generation circuit 8 further includes a pMOS transistor 8m connected at its source to the voltage stepdown input terminal 8a and connected at its drain to the gate of the nMOS transistor Tr1, an nMOS transistor 8n connected at its drain and gate to the drain of the pMOS transistor 8m, a voltage dividing resistor R_{stby1} connected at its first end to the nMOS transistor 8n at its source, a voltage dividing resistor R_{stby1} connected at its first end to a second end of the voltage dividing resistor R_{stby1}, a voltage dividing resistor R_{stby3} connected at its first end to a second end of the voltage dividing resistor R_{stby2}, and a voltage dividing resistor R_{stby4} connected between a second end of the voltage dividing resistor R_{stby3} and the ground.

The VINT generation circuit 8 further includes an nMOS transistor 8o connected at its drain and gate to the drain of the pMOS transistor 8m, a switch circuit 8p which is connected at its first end to the nMOS transistor 8o at its source and which turns on in accordance with activation signals ACT and /ACT, a voltage dividing resistor R_{ACT1} connected at its first end to a second end of the switch circuit 8p, a voltage dividing resistor R_{ACT2} connected at its first end to a second end of the voltage dividing resistor R_{ACT1} and the second end of the voltage dividing resistor R_{stby1}, a switch circuit 8q which is connected at its first end to a second end of the voltage dividing resistor R_{ACT2} and which turns on in accordance with the activation signals ACT and /ACT, a voltage dividing resistor R_{ACT3} connected at its first end to a second end of the switch circuit 8q, a voltage dividing resistor R_{ACT4} connected at its first end to a second end of the voltage dividing resistor R_{ACT3} and the second end of the voltage dividing resistor R_{stby3}, a switch circuit 8r which is connected between a second end of the voltage dividing resistor R_{ACT4} and the ground and which turns on in accordance with the activation signals ACT and /ACT, and an amplifier circuit 8s which compares a monitor voltage MONI3 between the voltage dividing resistor R_{stby3} and the voltage dividing resistor R_{stby4} with the reference voltage VREF and which outputs a voltage PGMONI3 depending upon a result of the comparison to a gate of the pMOS transistor 8m.

As shown in FIG. 13, each of the switch circuits 8p, 8q and 8r includes an nMOS transistor supplied at its gate with the activation signal ACT and a pMOS transistor supplied at its gate with an activation signal /ACT obtained by inverting the activation signal ACT and connected in parallel with the nMOS transistor.

The VINT generation circuit 8 is adapted to step down the stepped up voltage VPP_{High} and output a stepped down voltage VINT from the voltage stepdown output terminal 8b.

For example, before time t9 and after time t10 (Stby) already described and shown in FIG. 9, the switch circuits 8p, 8q and 8r turn off in accordance with the activation signals ACT and /ACT. As a result, the VINT generation circuit 8 is set to be less in current consumption but low in reactivity. On the other hand, between time t9 and t10 (ACT), the switch circuits 8p, 8q and 8r turn on in accordance with the activation signals ACT and /ACT. As a result, the VINT generation circuit 8 is set to be great in current consumption but high in reactivity.

As shown in FIGS. 11, 12 and 13 already described, the scheme called voltage stepdown transistor (giant transistor) is adopted to generate the stepped down voltages VINT, VAA and VDC.

For example, it is now supposed that gate potentials of the voltage stepdown transistors are respectively VG_{INT}, VG_{AA} and VG_{DC}, and conditions represented by the following Expressions (8) to (10) are satisfied.

VDD<VPP_{Low}<VG_{INT}<VPP_{High} (8)

VDD<VPP_{Low}<VG_{AA}<VPP_{High} (9)

VDD<VG_{DC}<VPP_{Low} (10)

In this case, the power supply voltage for the voltage stepdown transistors in the VINT generation circuit 7 and the VAA generation circuit 8 is set to the stepped up voltage VPP_{High} and the power supply voltage for the voltage stepdown transistors in the VDC generation circuit 6 is set to the stepped up voltage VPP_{Low}. As a result, the efficiency can be raised as compared with the case where the power supply voltage of all voltage stepdown transistors is generated from VPP_{High} as in the conventional art.

According to the internal power supply voltage generation circuit in the present embodiment, the voltages can be supplied more efficiently in the same way as the first embodiment as heretofore described.

### Third Embodiment

In the first embodiment, the case where the stepped up voltage VPP_{Low} and the stepped up voltage VPP_{High} rise at the same time has been described. In the first embodiment, the VPP_{Low} generation circuit causes the VDC potential to rise concurrently with supplying charge to the VPP_{High} generation circuit. Therefore, a heavy load is imposed on the VPP_{Low} generation circuit.

In a third embodiment, therefore, another operation of the memory system 1000 will be described.

The memory system according to the third embodiment has a configuration similar to that in the memory system 1000 according to the first embodiment shown in FIG. 1.

FIG. 14 is a diagram showing an example of a configuration of a reference potential generation circuit applied to the band gap reference (BGR) circuit and the reference potential generation circuit showing in FIG. 1.

As shown in FIG. 14, the potential generation circuits 2 and 3 are circuits which generate the reference voltage VREF to generate various internal power supply voltages.

The potential generation circuits 2 and 3 include pMOS transistors 302a to 302c, resistors R312 to R362, a diode 302d, n diodes 302e, and amplifier circuits 302f to 302h.

The potential generation circuit 2 generates the band gap reference potential VBGR, which is controlled by feedback conducted by the amplifier circuit 302f. The amplifier circuit 302g controls the pMOS transistor 302b on the basis of a result obtained by comparing the potential VBGR with a potential VREFA. In addition, the amplifier circuit 302h controls the nMOS transistor 302c on the basis of a result obtained by comparing a voltage VREFBI, which is obtained by dividing the external power supply voltage VDD with the resistors R342 and R352, with the voltage VREFA. As a result, a reference voltage VREFL is generated by dividing the voltage VREFA with the resistor R362, and output from a terminal 302i.

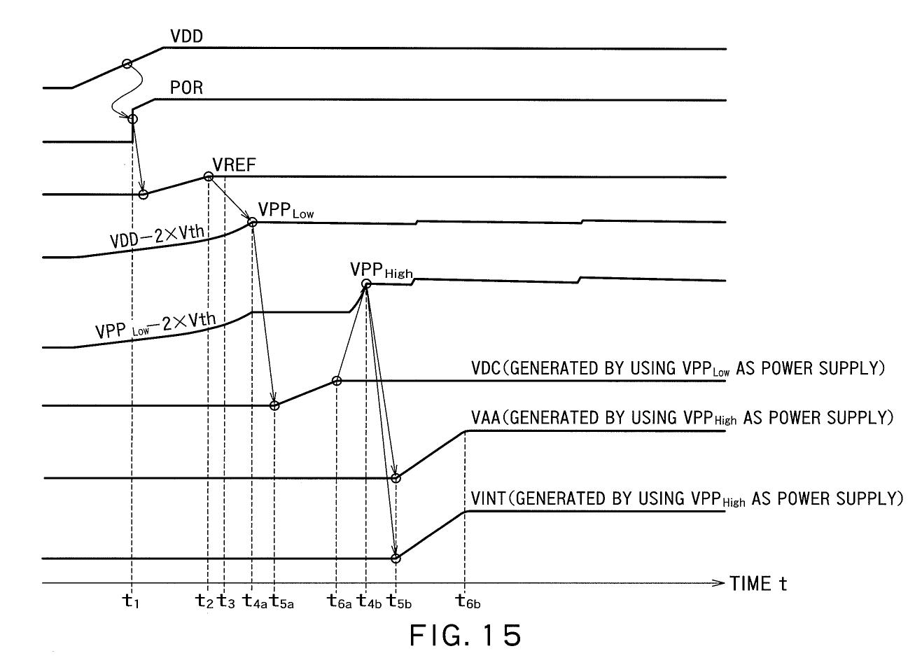

Operation of the memory system 1000 in the third embodiment will now be described. FIG. 15 is a timing chart showing an example of signal waveforms of various components in the memory system 1000.

In the same way as the first embodiment, the reference voltage VREF (VREFL) rises (time t2), then the VPP_{Low} generation circuit is started and generates the predetermined stepped up voltage VPP_{Low} (time t4a).

Then, the VDC generation circuit 6 is started (time t5a).

Then, the VDC generation circuit 6 steps down the stepped up voltage VPP_{Low} by using it as a power supply voltage, and generates the stepped down voltage (internal power supply voltage) VDC (time t6a).

Then, the VPP_{High} generation circuit 5 is started and generates the predetermined stepped up voltage VPP_{High} (time t4b).

Then, the VAA generation circuit 7 and the VINT generation circuit 8 are started (time t5b).

Then, the VAA generation circuit 7 and the VINT generation circuit 8 step down the stepped up voltage VPP_{High} by using it as a power supply voltage, and generate the stepped down voltage (internal power supply voltage) VINT and the stepped down voltage (array voltage) VAA (time t6b).

In this way, in the present third embodiment, the VPP_{Low} generation circuit 4 is caused to conduct voltage stepup operation and first only the stepped up voltage VPP_{Low} is caused to rise. Charge supply from the VPP_{Low} generation circuit 4 to the VDC generation circuit 6 is given priority. And the VDC generation circuit 6 is caused to conduct voltage stepdown operation. Then, after rise of the stepped down voltage VDC, the VPP_{High} generation circuit 5 is caused to conduct voltage stepup operation and the stepped up voltage VPP_{High} is caused to rise. Charge is supplied from the VPP_{High} generation circuit 5 to the VAA generation circuit 7 and the VINT generation circuit 8. And the VAA generation circuit 7 and the VINT generation circuit 8 are caused to conduct voltage stepdown operation.

As a result, the load imposed on the VPP_{Low} generation circuit can be reduced.

According to the internal power supply voltage generation circuit in the present embodiment, voltages can be supplied more efficiently as heretofore described. In addition, respective internal potentials can be stepped up without imposing an excessive burden on the voltage generation circuits.

### Fourth Embodiment

In a fourth embodiment, another configuration of the memory system will be described.

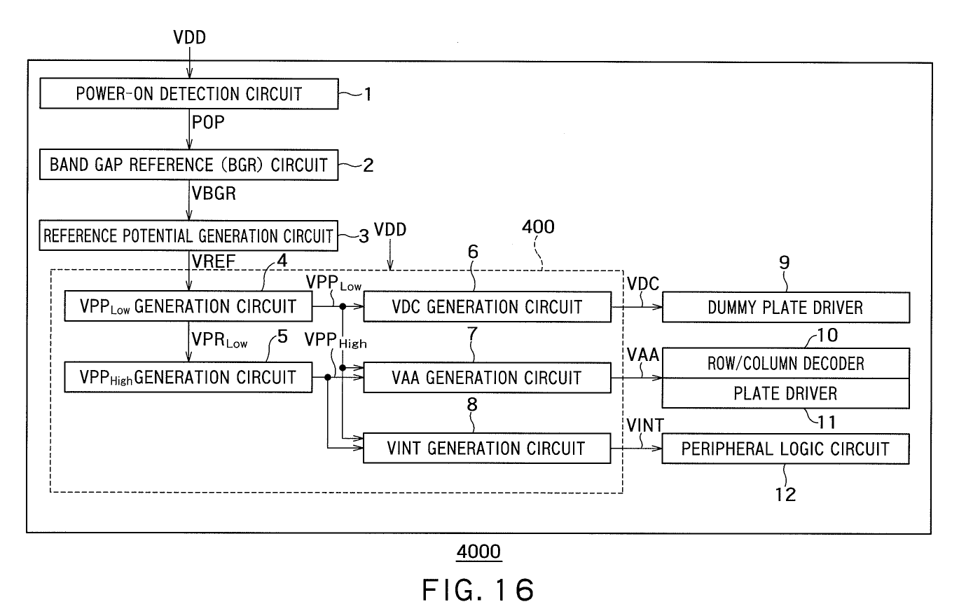

FIG. 16 is a block diagram showing an example of a memory system 4000 including an internal power supply voltage generation circuit 400 according to the fourth embodiment which is a mode of the present invention. In FIG. 16, the same characters as those in FIG. 1 denotes like components in the first embodiment.

As shown in FIG. 16, the memory system 4000 includes a power-on detection circuit 1, a band gap reference (BGR) circuit 2, a reference potential generation circuit 3, a VPP_{Low} generation circuit (charge pump circuit) 4, a VPP_{High} generation circuit (charge pump circuit) 5, a VDC generation circuit (voltage stepdown circuit) 6, a VAA generation circuit (voltage stepdown circuit) 7, a VINT generation circuit (voltage stepdown circuit) 8, a dummy plate driver 9, a row/column decoder 10, a plate driver 11, and a peripheral logic circuit 12.

The internal power supply voltage generation circuit 400 includes the VPP_{Low} generation circuit (charge pump circuit) 4, the VPP_{High} generation circuit (charge pump circuit) 5, the VDC generation circuit (voltage stepdown circuit) 6, the VAA generation circuit (voltage stepdown circuit) 7, and the VINT generation circuit (voltage stepdown circuit) 8 out of the above components.

As shown in FIG. 16, the VPP_{Low} generation circuit 4 is adapted to step up the external power supply voltage VDD and output the stepped up voltage VPP_{Low}. The VPP_{High} generation circuit 5 is adapted to step up the stepped up voltage VPP_{Low} and output the stepped up voltage VPP_{High} which is higher than the stepped up voltage VPP_{Low}.

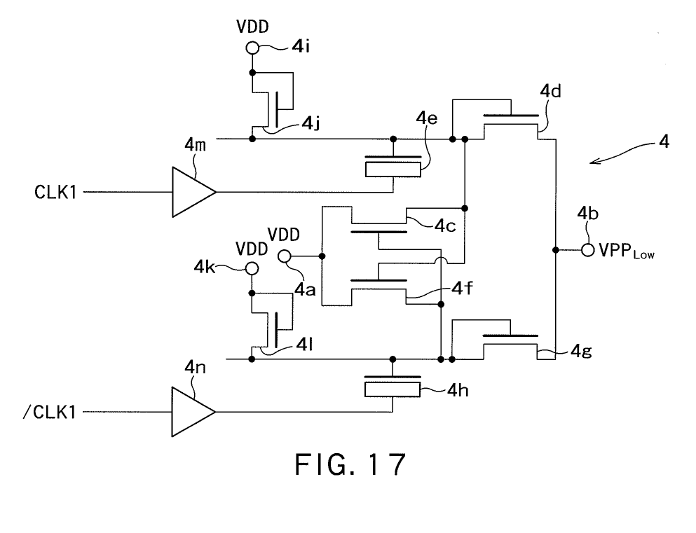

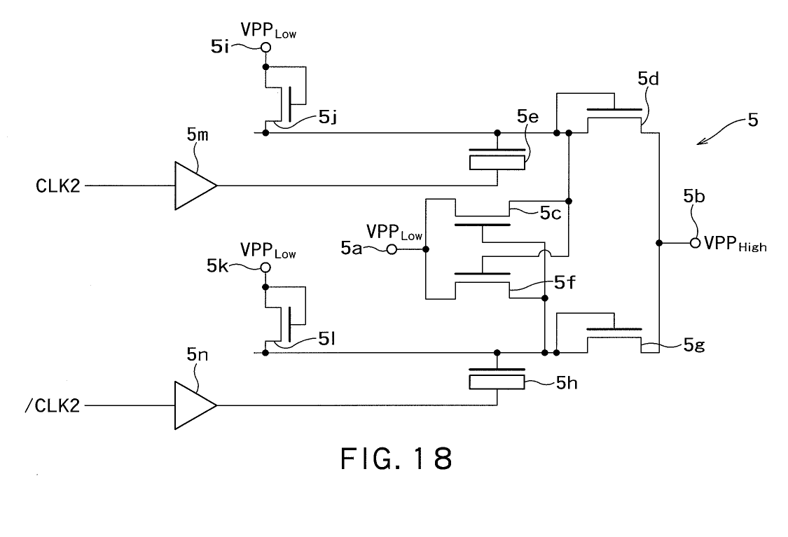

FIG. 17 is a circuit diagram showing an example of a configuration of the VPP_{Low} generation circuit (charge pump circuit) 4 shown in FIG. 16. FIG. 18 is a circuit diagram showing an example of a configuration of the VPP_{High} generation circuit (charge pump circuit) 5 shown in FIG. 16. The case where nMOS transistors are used will now be described with reference to FIGS. 17 and 18. However, the circuits may be formed of pMOS transistors to conduct similar operations.

As shown in FIG. 17, the VPP_{Low} generation circuit 4, which is the charge pump circuit, further includes, as compared with the circuit configuration in the first embodiment shown in FIG. 4, an nMOS transistor 4j diode-connected between a voltage stepup input terminal 4i and the gate of the MOS capacitor 4e, an nMOS transistor 4l diode-connected between a voltage stepup input terminal 4k and the gate of the MOS capacitor 4h, a driver 4m which amplifies the first clock signal CLK1 and outputs a resultant signal to the source and drain of the MOS capacitor 4e, and a driver 4n which amplifies the signal /CLK1 and outputs a resultant signal to the source and drain of the MOS capacitor 4h.

As a result, the potential at the voltage stepup terminal 4b is precharged to a value (VDD−2×Vth) obtained by subtracting threshold voltages Vth of two MOS transistors from the external power supply voltage VDD.

The VPP_{Low} generation circuit 4 is adapted to step up the external power supply voltage VDD and output the stepped up voltage VPP_{Low} from the voltage stepup output terminal 4b in accordance with the first clock signal CLK1 and the signal /CLK1.

As shown in FIG. 18, the VPP_{High} generation circuit 5, which is the charge pump circuit, further includes, as compared with the circuit configuration in the first embodiment shown in FIG. 5, an nMOS transistor 5j diode-connected between a voltage stepup input terminal 5i and the gate of the MOS capacitor 5e, an nMOS transistor 5l diode-connected between a voltage stepup input terminal 5k and the gate of the MOS capacitor 5h, a driver 5m which amplifies the second clock signal CLK2 and outputs a resultant signal to the source and drain of the MOS capacitor 5e, and a driver 5n which amplifies the signal /CLK2 and outputs a resultant signal to the source and drain of the MOS capacitor 5h.

As a result, the potential at the voltage stepup terminal 5b is precharged to a value (VPP_{Low}−2×Vth) obtained by subtracting threshold voltages Vth of two MOS transistors from the stepped up voltage VPP_{Low}.

The VPP_{High} generation circuit 5 is adapted to step up the stepped up voltage VPP_{Low} and output the stepped up voltage VPP_{High}, which is higher than the stepped up voltage VPP_{Low}, from the voltage stepup output terminal 5b in accordance with the second clock signal CLK2 and the signal /CLK2.

As shown in FIG. 16, the VDC generation circuit 6, which is the voltage stepdown circuit, is adapted to step down the stepped up voltage VPP_{Low}, generate a stepped down voltage VDC, which is an internal power supply voltage, and supply the stepped down voltage VDC to the dummy plate driver 9.

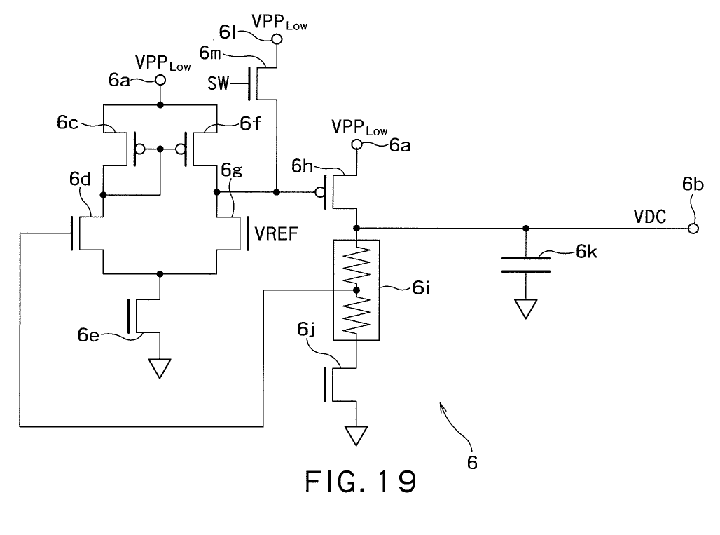

FIG. 19 is a circuit diagram showing an example of a configuration of the VDC generation circuit (voltage stepdown circuit) 6 shown in FIG. 16.

As shown in FIG. 19, the VDC generation circuit 6, which is the voltage stepdown circuit, further includes, as compared with the circuit configuration according to the first embodiment shown in FIG. 6, an nMOS transistor 6m connected between a voltage stepdown input terminal 6l and the gate of the pMOS transistor 6h.

For example, in the initial state, it is possible to apply the stepped up voltage VPP_{Low} to the gate of the pMOS transistor 6h and stabilize the potential at the voltage stepdown output terminal 6b by setting a signal SW, which is input to the nMOS transistor 6m at its gate, to a “low” level. In the voltage stepdown operation, the signal SW is set to a “high” level to turn the nMOS transistor 6m off

The VDC generation circuit 6 is adapted to generate the internal power supply voltage VDC, which is the stepped down voltage, by stepping down the stepped up voltage VPP_{Low} applied to the voltage stepdown input terminal 6a, and output the internal power supply voltage VDC to the voltage stepdown output terminal 6b.

As shown in FIG. 16, the VAA generation circuit 7, which is the voltage stepdown circuit, is adapted to step down the stepped up voltage VPP_{High}, generate a stepped down voltage VAA, which is an array voltage for supplying a potential to a memory cell array (not illustrated), and supply the stepped down voltage VAA to the row/column decoder 10 and the plate driver 11.

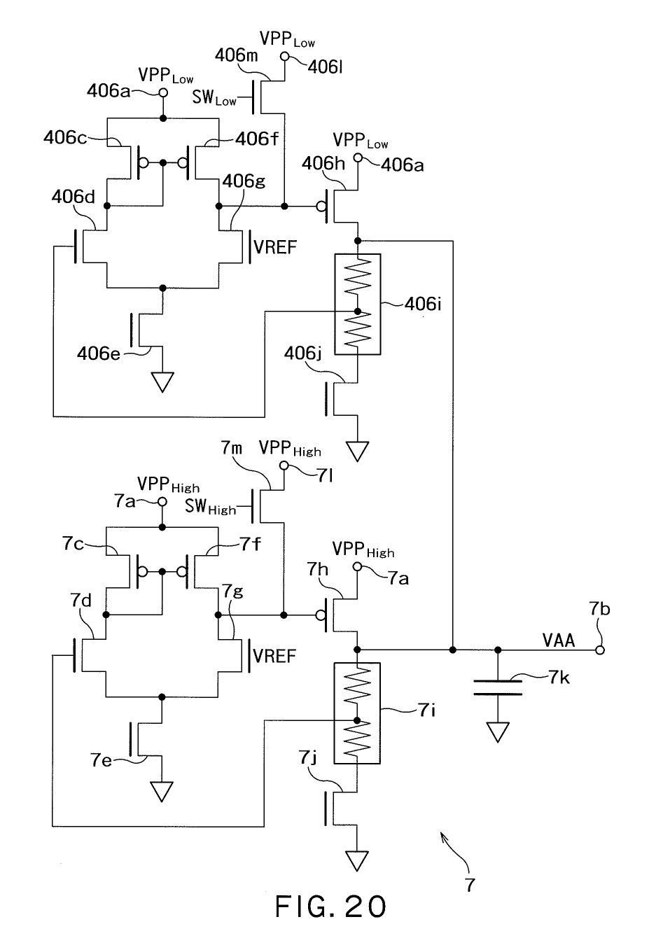

FIG. 20 is a circuit diagram showing an example of a configuration of the VAA generation circuit (voltage stepdown circuit) 7 shown in FIG. 16. The VINT generation circuit (voltage stepdown circuit) 8 shown in FIG. 16 also has a configuration similar to that shown in a circuit diagram in FIG. 20.

As shown in FIG. 20, the VAA generation circuit 7, which is the voltage stepdown circuit, further includes, as compared with the circuit configuration in the first embodiment shown in FIG. 7, a pMOS transistor 406c connected at its source to a voltage stepdown input terminal 406a, which is supplied with the stepped up voltage VPP_{Low}, and diode-connected, an nMOS transistor 406d connected to the pMOS transistor 406c at their drains, an nMOS transistor 406e connected between a source of the nMOS transistor 406d and the ground and supplied at its gate with a predetermined voltage, a pMOS transistor 406f connected at its source to the voltage stepdown input terminal 406a and connected to the pMOS transistor 406c at their gates, and an nMOS transistor 406g connected to the nMOS transistor 406f at their drains, connected at its source to the source of the nMOS transistor 406d, and supplied at its gate with the reference voltage VREF.

The VAA generation circuit 7 further includes a pMOS transistor 406h connected at its source to the voltage stepdown input terminal 406a, which is supplied with the stepped up voltage VPP_{Low}, connected at its gate to the pMOS transistor 406f at its drain, and connected at its drain to the voltage stepdown output terminal 7b, which outputs the stepped down voltage VAA, a voltage division circuit 406i connected at its first end to the drain of the pMOS transistor 406h to output a voltage obtained by dividing in voltage the stepped up voltage VPP_{Low} to a gate of the nMOS transistor 406d, and an nMOS transistor 406j connected between a second end of the voltage division circuit 406i and the ground and supplied at its gate with a predetermined voltage

The VAA generation circuit 7 further includes, as compared with the circuit configuration in the first embodiment shown in FIG. 7, an nMOS transistor 406m connected between a voltage stepdown input terminal 406l and the gate of the pMOS transistor 406h, and an nMOS transistor 7m connected between a voltage stepdown input terminal 7l and the gate of the pMOS transistor 7h.

For example, in the initial state, it is possible to apply the stepped up voltage VPP_{Low} and VPP_{High} respectively to gates of the nMOS transistors 406m and 7m and stabilize the potential at the voltage stepdown output terminal 7b by setting signals SW_{Low} and SW_{High}, which are respectively input to gates of the nMOS transistors 406m and 7m, to a “low” level. In the voltage stepdown operation, the signal SW_{Low} is set to a “high” level to turn the nMOS transistor 406m off, and then the signal SW_{High} is set to a “high” level to turn the nMOS transistor 7m off. As a result, the efficiency of charge supply can be improved.

The VAA generation circuit 7 is adapted to generate the stepped down voltage VAA by stepping down the stepped up voltage VPP_{High} applied to the voltage stepdown input terminal 7a and output the stepped down voltage VAA to the voltage stepdown output terminal 7b.

As shown in FIG. 16, the VINT generation circuit 8 is adapted to step down the stepped up voltage VPP_{High} and generate an internal power supply voltage VINT for driving the peripheral logic circuit 12 and the like. As already described, the VINT generation circuit (voltage stepdown circuit) 8 shown in FIG. 16 also has a configuration similar to that in the circuit diagram shown in FIG. 20.

In this way, the fourth embodiment differs from the first embodiment in that the stepped up voltage VPP_{Low} and the stepped up voltage VPP_{High} are used in the VAA generation circuit 7 and the VINT generation circuit 8.

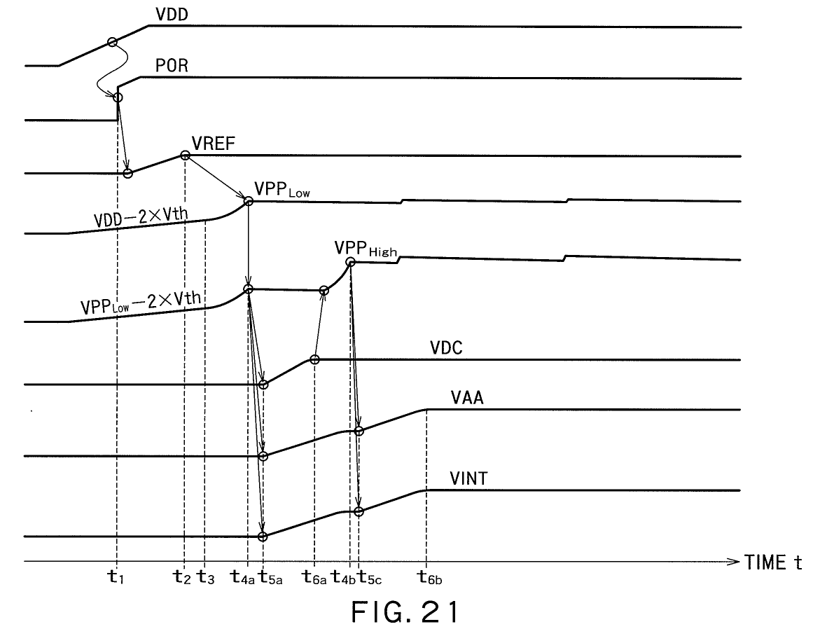

An example of operation of the memory system 4000 having the configuration described heretofore will now be described. FIG. 21 is a timing chart showing an example of signal waveforms of various components in the memory system 4000.

In the same way as the first embodiment, the reference voltage VREF rises (time t2), then the VPP_{Low} generation circuit 4 is started (time t3) and the VPP_{Low} generation circuit 4 generates the predetermined stepped up voltage VPP_{Low} (time t4a).

In the VPP_{Low} generation circuit 4 and the VPP_{High} generation circuit 5, the gates of the MOS capacitors are respectively precharged to VDD−2×Vth and VPP_{Low}−2×Vth at this time. Voltage stepup is conducted by drive of the MOS capacitors, and charge transfer is conducted. Therefore, the stepped up voltage VPP_{Low} rises in the wake of the rise of the external power supply voltage VDD, and the stepped up voltage VPP_{High} rises in the wake of the rise of the stepped up voltage VPP_{Low}.

Then, the VDC generation circuit 6, the VAA generation circuit 7, and the VINT generation circuit 8 are started by using the stepped up voltage VPP_{Low} as a power supply voltage (time t5a).

Then, the VDC generation circuit 6 steps down the stepped up voltage VPP_{Low} by using it as a power supply voltage, and generates the stepped down voltage (internal power supply voltage) VDC (time t6a).

Then, the VPP_{High} generation circuit 5 is started and the VPP_{High} generation circuit 5 generates the predetermined stepped up voltage VPP_{High} (time t4b).

Then, the VAA generation circuit 7 and the VINT generation circuit 8 operate by using the stepped up voltage VPP_{High} as a power supply voltage (time t5c).

Then, the VAA generation circuit 7 and the VINT generation circuit 8 steps down the stepped up voltage VPP_{High} by using it as a power supply voltage, and generate the stepped down voltage (internal power supply voltage) VINT and the stepped down voltage (array voltage) VAA (time t6b).

In this way, in the fourth embodiment, the VPP_{Low} generation circuit 4 is caused to conduct voltage stepup operation and first only the stepped up voltage VPP_{Low} is caused to rise. And the VDC generation circuit 6 is caused to conduct voltage stepdown operation.

In the present embodiment, there is a relation represented by the following expression (11). Although the stepped down voltage (internal power supply voltage) VDC rises up to the target arrival potential, however, the stepped down voltage (internal power supply voltage) VINT and the stepped down voltage (array voltage) VAA do not rise to the target arrival potential.

VDC<VPP_{Low}<VAA(VINT) (11)

After the rise of the stepped down voltage VDC, the VPP_{High} generation circuit 5 is caused to conduct voltage stepup operation and the stepped up voltage VPP_{High} is caused to rise. Charge is supplied from the VPP_{High} generation circuit 5 to the VAA generation circuit 7 and the VINT generation circuit 8. And the VAA generation circuit 7 and the VINT generation circuit 8 are caused to conduct the voltage stepdown operation.

After the rise of the stepped down voltage VDC, therefore, the VPP_{Low} generation circuit 4 can afford to supply charge to the VPP_{High} generation circuit 5, and consequently the load imposed on the VPP_{Low} generation circuit 4 can be reduced.

According to the internal power supply voltage generation circuit according to the present embodiment, the voltages can be supplied more efficiently as heretofore described.

### Fifth Embodiment

In a fifth embodiment, the case where the present invention is applied especially to a FeRAM (chain FeRAM) having a TC unit type memory cell array configuration will be described.

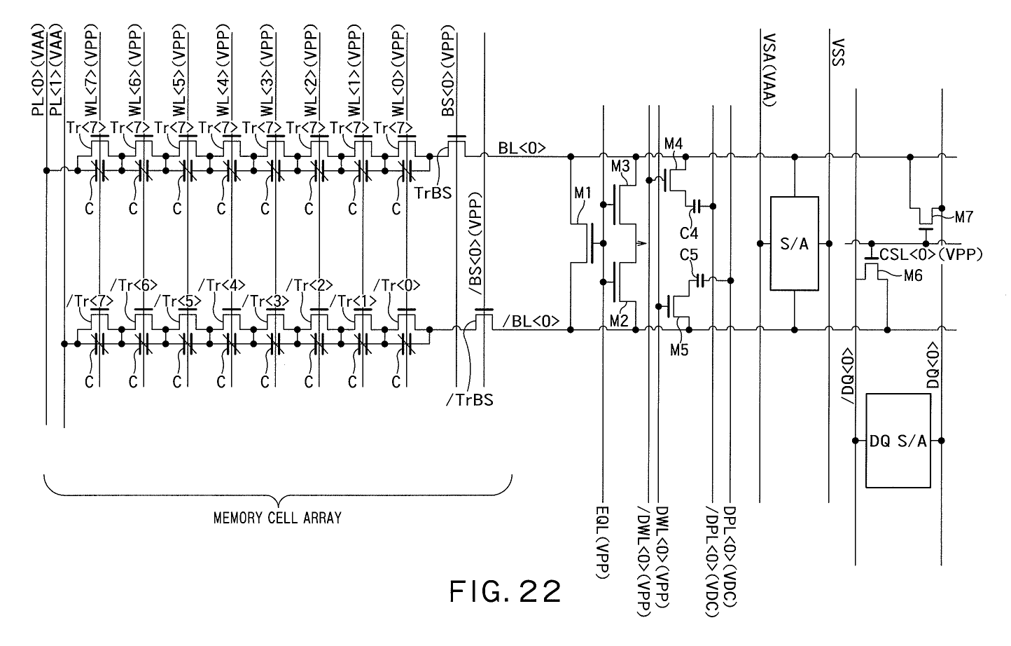

FIG. 22 is a circuit diagram showing an example of a ferroelectric memory apparatus having a TC unit type memory cell array configuration according to the fifth embodiment of the present invention.

As shown in FIG. 22, the ferroelectric memory apparatus includes a memory cell array formed by connecting ferroelectric capacitors C and MOS transistors Tr<0> to Tr<7> and /Tr<0> to /Tr<7> in parallel and in a chain form between plate lines PL<0> and PL<1> and block selection MOS transistors TrBS and /TrBS. Word lines WL<0> to WL<7> are connected to gates of the MOS transistors Tr<0> to Tr<7> and /Tr<0> to /Tr<7>, respectively. Selection lines BS<0> and /BS<0> are connected to gates of the block selection MOS transistors TrBS and /TrBS, respectively.

The ferroelectric memory apparatus further includes MOS transistors M1 to M7 connected to bit lines BL and /BL, a control line EQL connected to gates of the MOS transistors M1 to M3, word lines /DWL and DWL respectively connected to gates of the MOS transistors M4 and M5, and plate lines /DPL and DPL respectively connected to sources of the MOS transistors M4 and M5 via capacitors C4 and C5.

The ferroelectric memory apparatus further includes a sense amplifier S/A, a ground line VSS and a power supply line VSA connected to the sense amplifier S/A, a control line CSL<0> connected to gates of the MOS transistors M6 and M7, a sense amplifier DQS/A, and output lines DQ and /DQ.

As shown in FIG. 22, voltages depending upon the stepped up voltages VPP (stepped up voltages VPP_{Low} and VPP_{High}) are supplied to the word lines WL<0> to WL<7>, the selection lines BS<0> and /BS<0>, the control line EQL, the word lines /DWL and DWL, and the control line CSL<0>. The stepped down voltage VAA is supplied to the plate lines PL<0> and PL<1> and the power supply line VSA. The stepped down voltage VDC is supplied to the plate lines /DPL and DPL.

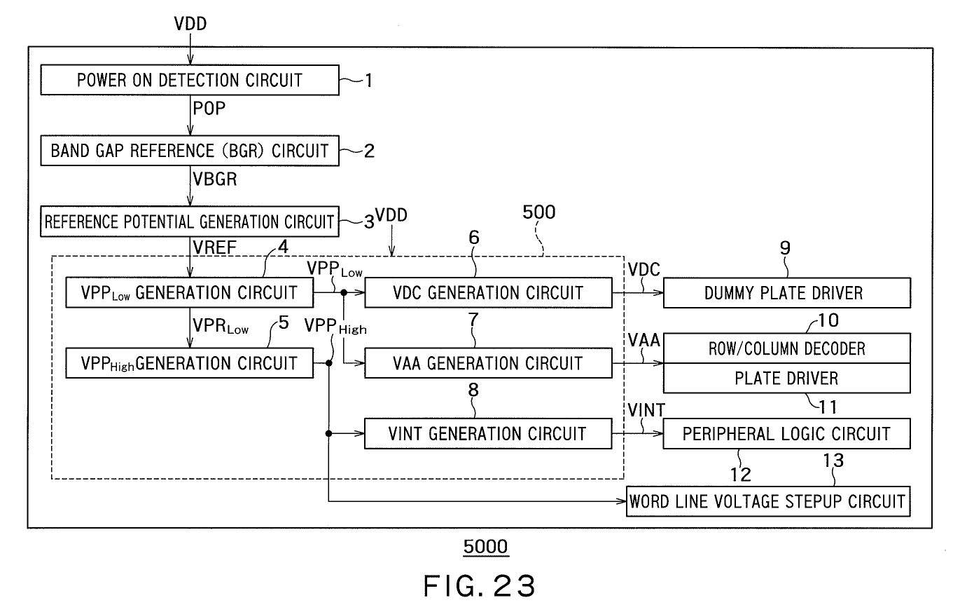

FIG. 23 is a block diagram showing an example of a memory system 5000 including an internal power supply voltage generation circuit 500 according to the fifth embodiment which is a mode of the present invention. In FIG. 23, the same characters as those in FIG. 1 denote like components in the first embodiment unless especially stated otherwise.

As shown in FIG. 23, the memory system 5000 includes a power-on detection circuit 1, a band gap reference (BGR) circuit 2, a reference potential generation circuit 3, a VPP_{Low} generation circuit (charge pump circuit) 4, a VPP_{High} generation circuit (charge pump circuit) 5, a VDC generation circuit (voltage stepdown circuit) 6, a VAA generation circuit (voltage stepdown circuit) 7, a VINT generation circuit (voltage stepdown circuit) 8, a dummy plate driver 9, a row/column decoder 10, a plate driver 11, peripheral logic circuit 12, and a word line charge pump circuit 13.

The internal power supply voltage generation circuit 500 includes the VPP_{Low} generation circuit (charge pump circuit) 4, the VPP_{High} generation circuit (charge pump circuit) 5, the VDC generation circuit (voltage stepdown circuit) 6, the VAA generation circuit (voltage stepdown circuit) 7, and the VINT generation circuit (voltage stepdown circuit) 8 out of the above components.

The VPP_{Low} generation circuit 4 is adapted to step up the external power supply voltage VDD and output the stepped up voltage VPP_{Low}. The VPP_{High} generation circuit 5 is adapted to step up the stepped up voltage VPP_{Low} and output the stepped up voltage VPP_{High}, which is higher than the stepped up voltage VPP_{Low}.

The VDC generation circuit 6, which is the voltage stepdown circuit, is adapted to step down the stepped up voltage VPP_{Low}, generate a stepped down voltage VDC, which is the internal power supply voltage, and supply the stepped down voltage VDC to the dummy plate driver 9.

The VAA generation circuit 7, which is the voltage stepdown circuit, is adapted to step down the stepped up voltage VPP_{Low}, generate a stepped down voltage VAA, which is an array voltage for supplying a potential to a memory cell array (not illustrated), and supply the stepped down voltage VAA to the row/column decoder 10 and the plate driver 11.

The VINT generation circuit 8 is adapted to step down the stepped up voltage VPP_{High} and generate an internal power supply voltage VINT for driving the peripheral logic circuit 12 and the like.

The word line charge pump circuit 13 is adapted to generate a voltage to be supplied to a word line on the basis of the stepped up voltage VPP_{High}.

Since the FeRAM undergoes destructive readout and it is non-volatile, it is necessary to take care of especially data destruction or false writing when starting the power supplies.

Considering that the FeRAM is a FeRAM (chain RAM) having a TC unit type memory cell array configuration, startup of various internal power supplies is conducted in the following order: first, the stepped up voltages VPP_{Low} and VPP_{High}, secondly, the stepped down voltage (internal power supply voltage) VINT, and thirdly, the stepped down voltage (array voltage) VAA/the stepped down voltage (internal power supply voltage) VDC.

In the TC unit type memory cell array configuration, electrodes of the ferroelectric capacitor are short-circuited to each other and no potential difference is imposed by starting the stepped up voltages VPP_{Low} and VPP_{High} earliest. As a result, false reading and false writing can be suppressed.

Also, by starting the voltage stepdown voltage (internal power supply voltage) VINT secondly, it is possible to cause the peripheral circuit which controls cores to operate certainly to prevent false selection of a core.

Finally, the stepped down voltage (array voltage) VAA/the stepped down voltage (internal power supply voltage) VDC which directly enters the core is started.

On the basis of such a study, an example of operation of the memory system 5000 having the configuration described heretofore will be described.

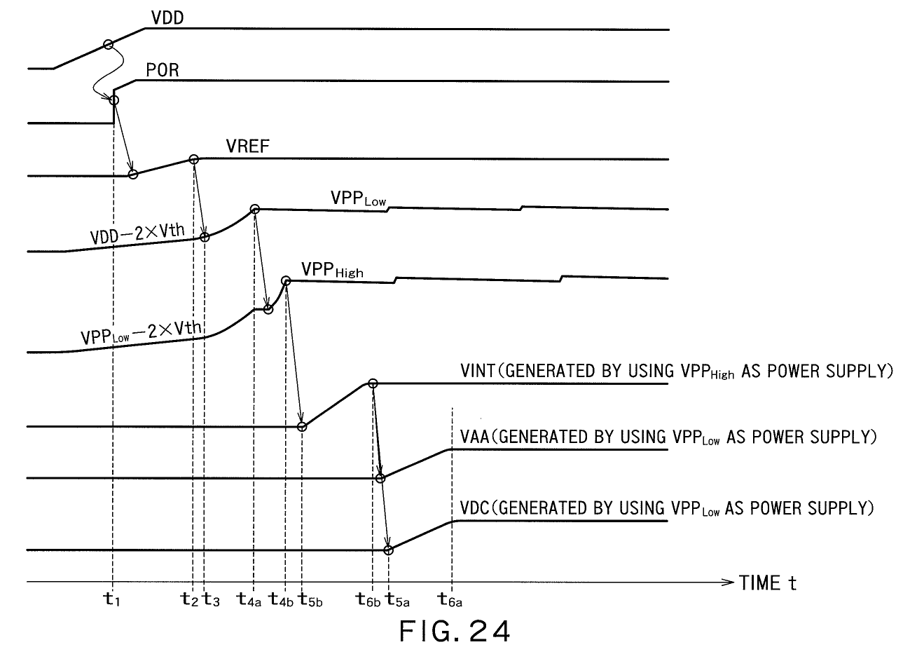

FIG. 24 is a timing chart showing an example of signal waveforms of various components in the memory system 5000.

In the same way as the first embodiment, the reference voltage VREF rises (time t2), then the VPP_{Low} generation circuit is started (time t3) and the VPP_{Low} generation circuit 4 generates the predetermined stepped up voltage VPP_{Low} (time t4a).

In the VPP_{Low} generation circuit 4 and the VPP_{High} generation circuit 5, the gates of the MOS capacitors are respectively precharged to VDD−2×Vth and VPP_{Low}−2×Vth at this time. Voltage stepup is conducted by drive of the MOS capacitors, and charge transfer is conducted. Therefore, the stepped up voltage VPP_{Low} rises in the wake of the rise of the external power supply voltage VDD, and the stepped up voltage VPP_{High} rises in the wake of the rise of the stepped up voltage VPP_{Low}.

Then, the VPP_{High} generation circuit 5 is started and generates the predetermined stepped up voltage VPP_{High} (time t4b).

Then, the VINT generation circuit 8 is started (time t5b).

Then, the VINT generation circuit 8 steps down the stepped up voltage VPP_{High} by using it as a power supply voltage and generates the stepped down voltage (internal power supply voltage) VINT (time t6b).

Then, the VDC generation circuit 6 and the VAA generation circuit 7 are started (time t5a).

Then, the VDC generation circuit 6 and the VAA generation circuit 7 step down the stepped up voltage VPP_{Low} by using it as a power supply voltage, and generate the stepped down voltage (internal power supply voltage) VDC and the stepped down voltage (array voltage) VAA (time t6a).

Considering that the FeRAM is a FeRAM (chain RAM) having a TC unit type memory cell array configuration, startup of various internal power supplies is conducted in the following order: first, the stepped up voltages VPP_{Low} and VPP_{High}, secondly, the stepped down voltage (internal power supply voltage) VINT, and thirdly, the stepped down voltage (array voltage) VAA/the stepped down voltage (internal power supply voltage) VDC.

According to the internal power supply voltage generation circuit in the present embodiment, the voltages can be supplied more efficiently as described heretofore. In addition, the operation of the FeRAM can be further rationalized.

### Sixth Embodiment

In a sixth embodiment, the case where the present invention is applied to a ferroelectric memory apparatus having a memory cell array formed by replacing MOS capacitors in the DRAM made of a paraelectric substance with ferroelectric capacitors will be described.

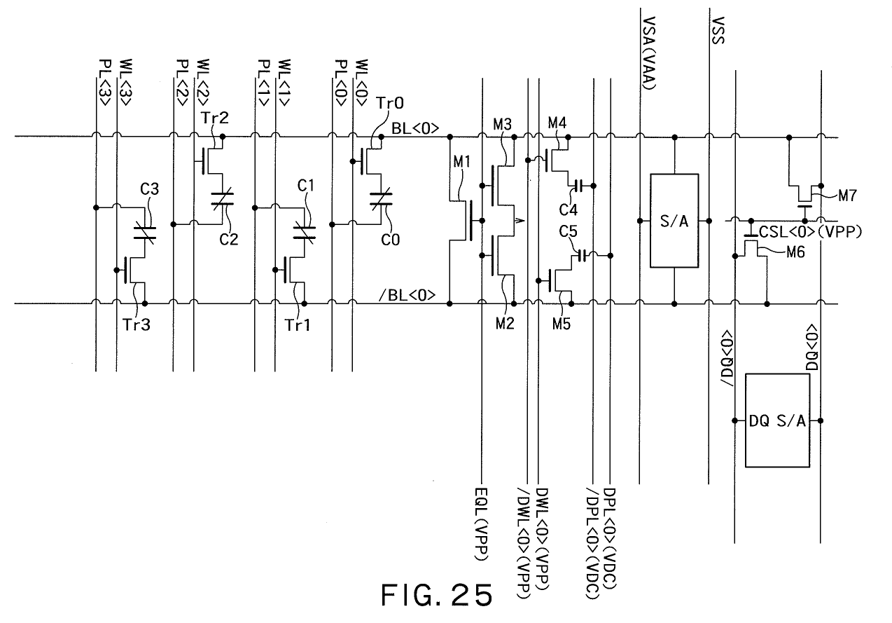

FIG. 25 is a circuit diagram showing an example of a ferroelectric memory apparatus according to the sixth embodiment of the present invention.

As shown in FIG. 25, the ferroelectric memory apparatus includes a memory cell array formed by connecting ferroelectric capacitors C0 and C2 and MOS transistors Tr0 and Tr2 respectively in series between plate lines PL<0> and PL<2> and a bit line BL<0>, respectively, and connecting ferroelectric capacitors C1 and C3 and MOS transistors Tr1 and Tr3 respectively in series between plate lines PL<1> and PL<3> and a bit line /BL<0>, respectively.

Word lines WL<0> to WL<3> are connected to gates of the MOS transistors Tr0 to Tr3, respectively.

In the same way as the fifth embodiment, the ferroelectric memory apparatus further includes MOS transistors M1 to M7 connected to bit lines BL and /BL, a control line EQL connected to gates of the MOS transistors M1 to M3, word lines /DWL and DWL respectively connected to gates of the MOS transistors M4 and M5, and plate lines /DPL and DPL respectively connected to sources of the MOS transistors M4 and M5 via capacitors C4 and C5

In the same way as the fifth embodiment, the ferroelectric memory apparatus further includes a sense amplifier S/A, a ground line VSS and a power supply line VSA connected to the sense amplifier S/A, a control line CSL<0> connected to gates of the MOS transistors M6 and M7, a sense amplifier DQS/A, and output lines DQ and /DQ.

Voltages depending upon the stepped up voltages VPP (stepped up voltages VPP_{Low} and VPP_{High}) are supplied to the word lines WL<0> to WL<3>, the control line EQL, the word lines /DWL and DWL, and the control line CSL<0>. The stepped down voltage VAA is supplied to the plate lines PL<0> and PL<1> and the power supply line VSA. The stepped down voltage VDC is supplied to the plate lines /DPL and DPL.

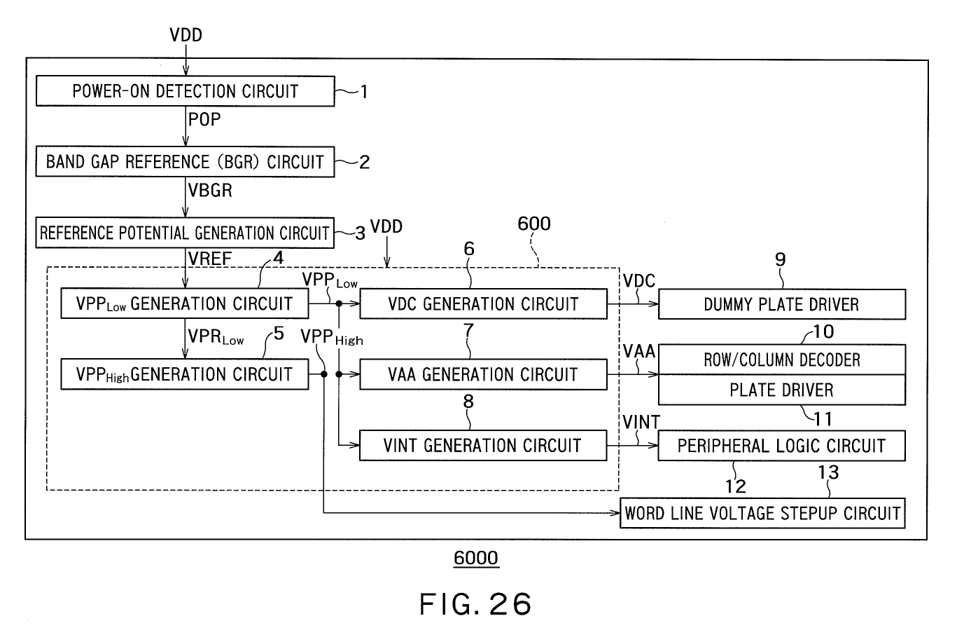

FIG. 26 is a block diagram showing an example of a memory system 6000 including an internal power supply voltage generation circuit 600 according to the sixth embodiment which is a mode of the present invention. In FIG. 26, the same characters as those in FIG. 1 denote like components in the first embodiment unless especially stated otherwise.

As shown in FIG. 26, the memory system 6000 includes a power-on detection circuit 1, a band gap reference (BGR) circuit 2, a reference potential generation circuit 3, a VPP_{Low} generation circuit (charge pump circuit) 4, a VPP_{High} generation circuit (charge pump circuit) 5, a VDC generation circuit (voltage stepdown circuit) 6, a VAA generation circuit (voltage stepdown circuit) 7, a VINT generation circuit (voltage stepdown circuit) 8, a dummy plate driver 9, a row/column decoder 10, a plate driver 11, peripheral logic circuit 12, and a word line charge pump circuit 13.

The internal power supply voltage generation circuit 600 includes the VPP_{Low} generation circuit (charge pump circuit) 4, the VPP_{High} generation circuit (charge pump circuit) 5, the VDC generation circuit (voltage stepdown circuit) 6, the VAA generation circuit (voltage stepdown circuit) 7, and the VINT generation circuit (voltage stepdown circuit) 8 out of the above components.

The VPP_{Low} generation circuit 4 is adapted to step up the external power supply voltage VDD and output the stepped up voltage VPP_{Low}. The VPP_{High} generation circuit 5 is adapted to step up the stepped up voltage VPP_{Low} and output the stepped up voltage VPP_{High}, which is higher than the stepped up voltage VPP_{Low}.

The VDC generation circuit 6, which is the voltage stepdown circuit, is adapted to step down the stepped up voltage VPP_{Low}, generate a stepped down voltage VDC, which is the internal power supply voltage, and supply the stepped down voltage VDC to the dummy plate driver 9.

The VAA generation circuit 7, which is the voltage stepdown circuit, is adapted to step down the stepped up voltage VPP_{Low}, generate a stepped down voltage VAA, which is an array voltage for supplying a potential to a memory cell array (not illustrated), and supply the stepped down voltage VAA to the row/column decoder 10 and the plate driver 11.

The VINT generation circuit 8 is adapted to step down the stepped up voltage VPP_{High} and generate an internal power supply voltage VINT for driving the peripheral logic circuit 12 and the like.

The word line charge pump circuit 13 is adapted to generate a voltage to be supplied to a word line on the basis of the stepped up voltage VPP_{High}.

Since the FeRAM undergoes destructive readout and it is non-volatile, it is necessary to take care of especially data destruction or false writing when starting the power supplies.

Paying attention to the ferroelectric capacitors in the FeRAM of DRAM type, startup of various internal power supplies is conducted in the following order: first, the stepped down voltage (internal power supply voltage) VINT, secondly, the stepped down voltage (array voltage) VAA/the stepped down voltage (internal power supply voltage) VDC, and thirdly, the stepped up voltages VPP_{Low} and VPP_{High}.

It is possible to cause the peripheral circuit which controls the core to operate certainly to prevent false selection of a core by starting the stepped down voltage (internal power supply voltage) VINT first.

Then, the stepped down voltage (array voltage) VAA/the stepped down voltage (internal power supply voltage) VDC which directly enters the core is started.

If a word line is selected in the case of the FeRAM of DRAM type, there is a risk of false reading and false writing. Therefore, the stepped up voltages VPP_{Low} and VPP_{High} are started finally.

On the basis of such a study, an example of operation of the memory system 6000 having the configuration described heretofore will be described.

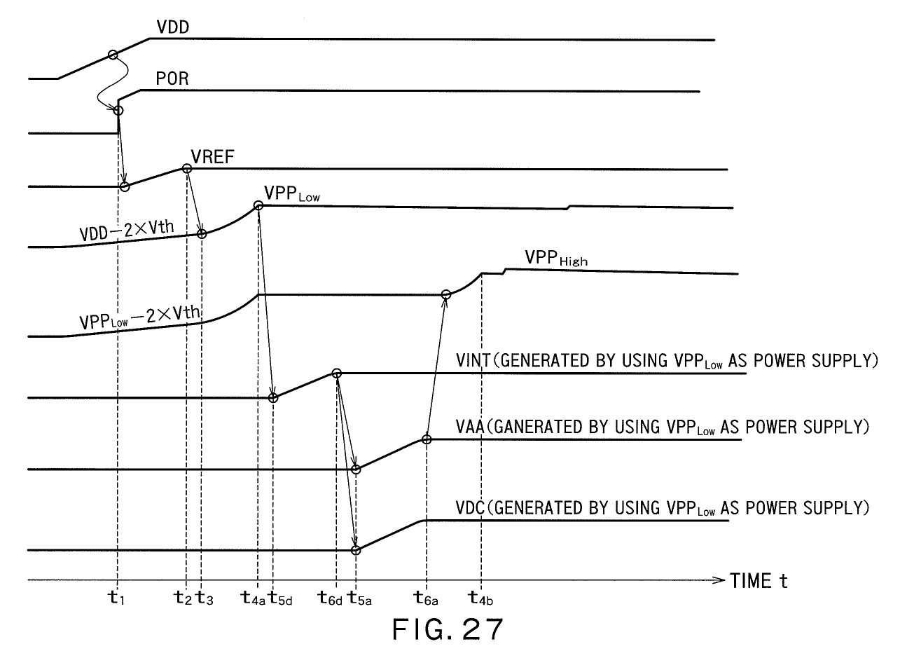

FIG. 27 is a timing chart showing an example of signal waveforms of various components in the memory system 6000.

In the same way as the fifth embodiment, the reference voltage VREF rises (time t2), then the VPP_{Low} generation circuit is started (time t3) and the VPP_{Low} generation circuit 4 generates the predetermined stepped up voltage VPP_{Low} (time t4a).

In the VPP_{Low} generation circuit 4 and the VPP_{High} generation circuit 5, the gates of the MOS capacitors are respectively precharged to VDD−2×Vth and VPP_{Low}−2×Vth at this time. Voltage stepup is conducted by drive of the MOS capacitors, and charge transfer is conducted. Therefore, the stepped up voltage VPP_{Low} rises in the wake of the rise of the external power supply voltage VDD, and the stepped up voltage VPP_{High} rises in the wake of the rise of the stepped up voltage VPP_{Low}.

Then, the VINT generation circuit 8 is started (time t5d).

Then, the VINT generation circuit 8 steps down the stepped up voltage VPP_{Low} by using it as a power supply voltage and generates the stepped down voltage (internal power supply voltage) VINT (time t6d).

Then, the VDC generation circuit 6 and the VAA generation circuit 7 are started (time t5a).

Then, the VDC generation circuit 6 and the VAA generation circuit 7 step down the stepped up voltage VPP_{Low} by using it as a power supply voltage, and generate the stepped down voltage (internal power supply voltage) VDC and the stepped down voltage (array voltage) VAA (time t6a).

Then, the VPP_{High} generation circuit 5 is started and generates the predetermined stepped up voltage VPP_{High} (time t4b).

Paying attention to the ferroelectric capacitors in the FeRAM of DRAM type, startup of various internal power supplies is conducted in the following order: first, the stepped down voltage (internal power supply voltage) VINT, secondly, the stepped down voltage (array voltage) VAA/the stepped down voltage (internal power supply voltage) VDC, and thirdly, the stepped up voltages VPP_{Low} and VPP_{High}.

According to the internal power supply voltage generation circuit in the present embodiment, the voltages can be supplied more efficiently as described heretofore. In addition, the operation of the FeRAM can be further rationalized.

What is claimed is:

1. An internal power supply voltage generator comprising:
a first charge pump configured to step up an external power supply voltage, supplied at a first voltage stepup input terminal, to a first stepped up voltage, output at a first voltage stepup output terminal, in response to a first clock signal, said first charge pump comprising:
a first MOS transistor comprising a drain connected to the first voltage stepup input terminal, and a source;
a second MOS transistor comprising a drain connected to the source of the first MOS transistor, a gate connected to the source of the first MOS transistor, and a source connected to the first voltage stepup output terminal; and
a first MOS capacitor comprising a gate connected to the source of the first MOS transistor, a source connected to the first clock signal, and a drain connected to the first clock signal;
a second charge pump configured to step up the first stepped up voltage, supplied at a second voltage stepup input terminal, to a second stepped up voltage, output at a second stepup output terminal, in response to a second clock signal, the second stepped up voltage being higher than the first stepped up voltage, said second charge pump comprising:
a third MOS transistor comprising a drain connected to the second voltage stepup input terminal, and a source;
a fourth MOS transistor comprising a drain connected to the source of the third MOS transistor, a gate connected to the source of the third MOS transistor, and a source connected to the second voltage stepup output terminal; and
a second MOS capacitor comprising a gate connected to the source of the third MOS transistor, a source connected to the second clock signal, and a drain connected to the second clock signal;
a first voltage stepdown circuit configured to step down the first stepped up voltage to a first stepped down voltage; and
a second voltage stepdown circuit configured to step down the second stepped up voltage to a second stepped down voltage, the second stepped down voltage being higher than the first stepped up voltage.

2. The internal power supply voltage generator of claim 1, wherein the first charge pump comprises:
a fifth MOS transistor comprising a drain connected to the first voltage stepup input terminal, a source connected to a gate of the first MOS transistor, and a gate connected to the source of the first MOS transistor;
a sixth MOS transistor comprising a drain connected to the source of the fifth MOS transistor, a gate connected to the source of the fifth MOS transistor, and a source connected to the first voltage stepup output terminal;
a third MOS capacitor comprising a gate connected to the source of the fifth MOS transistor, a source connected to an inverted phase of the first clock signal, and a drain connected to the inverted phase of the first clock signal;
a seventh MOS transistor comprising a drain connected to the second voltage stepup input terminal, a source connected to a gate of the third MOS transistor, and a gate connected to the source of the third MOS transistor;
an eighth MOS transistor comprising a drain connected to the source of the seventh MOS transistor, a gate connected to the source of the seventh MOS transistor, and a source connected to the second voltage stepup output terminal; and
a fourth MOS capacitor comprising a gate connected to the source of the seventh MOS transistor, a source connected to an inverted phase of the second clock signal, and a drain connected to the inverted phase of the second clock signal.

3. The internal power supply voltage generator of claim 1, comprising:
a first output resistor connected between the first voltage stepup output terminal and the second voltage stepup output terminal; and
a second output resistor connected between the first voltage stepup output terminal and ground;
wherein the first charge pump is configured to operate concurrently with the second charge pump before deactivating, and wherein the second charge pump is configured to continue to operate after the first charge pump deactivates.

4. The internal power supply voltage generator of claim 2, comprising:
a first output resistor connected between the first voltage stepup output terminal and the second voltage stepup output terminal; and
a second output resistor connected between the first voltage stepup output terminal and ground;
wherein the first charge pump is configured to operate concurrently with the second charge pump before deactivating, and wherein the second charge pump is configured to continue to operate after the first charge pump deactivates.

5. The internal power supply voltage generator of claim 1, wherein:
the first voltage stepdown circuit is configured to operate after the first charge pump is operational, and
the second voltage stepdown circuit is configured to operate after the second charge pump is operational.

6. The internal power supply voltage generator of claim 2, wherein:
the first voltage stepdown circuit is configured to operate after the first charge pump is operational, and
the second voltage stepdown is configured to operate after the second charge pump is operational.

7. The internal power supply voltage generator of claim 1, wherein the first through fourth transistors are nMOS transistors.

8. The internal power supply voltage generator of claim 1, wherein the first through fourth transistors are pMOS transistors.

9. The internal power supply voltage generator of claim 2, wherein the first through eighth transistors are nMOS transistors.

10. The internal power supply voltage generator of claim 2, wherein the first through eighth transistors are pMOS transistors.

11. The internal power supply voltage generator of claim 3, wherein the first through fourth transistors are nMOS transistors.

12. The internal power supply voltage generator of claim 3, wherein the first through fourth transistors are pMOS transistors.

13. The internal power supply voltage generator of claim 4, wherein the first through eighth transistors are nMOS transistors.

14. The internal power supply voltage generator of claim 4, wherein the first through eighth transistors are pMOS transistors.

15. An internal power supply voltage generator comprising:
a first charge pump configured to step up an external power supply voltage to a first stepped up voltage, output at a first voltage stepup output terminal;
a second charge pump circuit configured to step up the first stepup voltage to a second stepped up voltage, output at a second voltage stepup output terminal, the second stepped up voltage being higher than the first stepped up voltage;
a first voltage stepdown circuit configured to step down the first stepped up voltage, supplied at a first voltage stepdown input terminal, to a first stepped down voltage, output at a first voltage stepdown output terminal, said first voltage stepdown circuit comprising:
a first MOS transistor comprising an nMOS transistor comprising a gate, said first MOS transistor being connected between a first voltage stepdown input terminal and a first voltage stepdown output terminal;
a second MOS transistor comprising an nMOS transistor comprising a gate connected to the gate of the first MOS transistor, said second MOS transistor being connected between the first voltage stepdown input terminal and the first voltage stepdown output terminal; and
a third MOS transistor comprising a pMOS transistor connected between the first voltage stepdown input terminal and the first MOS transistor; and
a second voltage stepdown circuit configured to step down the second stepped down voltage, supplied to a second stepdown input terminal, to a second stepped down voltage, output at a second voltage stepdown output terminal, said second voltage stepdown circuit comprising:
a fourth MOS transistor comprising an nMOS transistor comprising a gate, said fourth MOS transistor being connected between the second voltage stepdown input terminal and the second voltage stepdown output terminal;
a fifth MOS transistor comprising an nMOS transistor comprising a gate connected to the gate of the fourth MOS transistor, said fifth MOS transistor being connected between the second voltage stepdown input terminal and the second voltage stepdown output terminal; and
a sixth MOS transistor comprising a pMOS transistor connected between the second voltage stepdown input terminal and the fourth MOS transistor;
wherein a gate voltage of the first MOS transistor is higher than the external power supply voltage and is lower than the first stepped up voltage; and
wherein a gate voltage of the fourth MOS transistor is higher than the first stepped up voltage and is lower than the second stepped up voltage.

16. The internal power supply voltage generator of claim 15, wherein the first voltage stepdown circuit comprises:
a seventh MOS transistor comprising a pMOS transistor comprising a source connected to the first voltage stepdown input terminal, and a drain connected to the gate of the first MOS transistor;
an eighth MOS transistor comprising an nMOS transistor comprising a source, a drain connected to the drain of the seventh MOS transistor, and a gate connected to the drain of the seventh MOS transistor;
a first voltage dividing resistor comprising a first end and a second end, the first end being connected to the source of the eighth MOS transistor;
a second voltage dividing resistor connected between the second end of the first voltage dividing resistor and ground;
a ninth MOS transistor comprising an nMOS transistor comprising a source, a drain connected to the drain of the seventh MOS transistor, and a gate connected to the drain of the seventh MOS transistor;
a first switch comprising a first end and a second end, the first end being connected to the source of the ninth MOS transistor, and said first switch being configured to turn on in accordance with a first activation signal;
a third voltage dividing resistor comprising a first end and a second end, the first end being connected to the second end of the first switch circuit;
a fourth voltage dividing resistor comprising a first end and a second end, the first end being connected to the both the second end of the third voltage dividing resistor and the second end of the first voltage dividing resistor;
a second switch connected between the second end of the fourth voltage dividing resistor and ground, said second switch being configured to turn on in accordance with the first activation signal;
a first amplifier configured to compare a first monitor voltage between the first voltage dividing resistor and the second voltage dividing resistor with a reference voltage, said first amplifier being further configured to output a voltage depending upon a result of the comparison; and
wherein the second voltage stepdown circuit comprises:
a tenth MOS transistor comprising a pMOS transistor comprising a source connected to the second voltage stepdown input terminal, and a drain connected to the gate of the fourth MOS transistor;
an eleventh MOS transistor comprising an nMOS transistor comprising a source, a drain connected to the drain of the tenth MOS transistor, and a gate connected to the drain of the tenth MOS transistor;
a fifth voltage dividing resistor comprising a first end and a second end, the first end being connected to the source of the eleventh MOS transistor;
a sixth voltage dividing resistor connected between the second end of the fifth voltage dividing resistor and ground;
a twelfth MOS transistor comprising an nMOS transistor comprising a source, a drain connected to the drain of the tenth MOS transistor, and a gate connected to the drain of the tenth MOS transistor;
a third switch comprising a first end and a second end, the first end being connected to the source of the twelfth MOS transistor, said third switch being configured to turn on in accordance with a second activation signal;
a seventh voltage dividing resistor comprising a first end and a second end, the first end being connected to the second end of the third switch circuit;
an eighth voltage dividing resistor comprising a first end and a second end, the first end being connected to both the second end of the seventh voltage dividing resistor and the second end of the fifth voltage dividing resistor;
a fourth switch connected between the second end of the eighth voltage dividing resistor and ground, said fourth switch being configured to turn on in accordance with the second activation signal;
a second amplifier configured to compare a second monitor voltage between the fifth voltage dividing resistor and the sixth voltage dividing resistor with the reference voltage, said second amplifier being further configured to output a voltage depending upon a result of the comparison.

17. The internal power supply voltage generator of claim 15, comprising:
a first output resistor connected between the first voltage stepup output terminal and the second voltage stepup output terminal; and
a second output resistor connected between the first voltage stepup output terminal and a ground;
wherein the first charge pump is configured to operate concurrently with the second charge pump before deactivating, and wherein the second charge pump is configured to continue to operate after the first charge pump deactivates.

18. The internal power supply voltage generator of claim 16, comprising:
a first output resistor connected between the first voltage stepup output terminal and the second voltage stepup output terminal; and
a second output resistor connected between the first voltage stepup output terminal and a ground;
wherein the first charge pump is configured to operate concurrently with the second charge pump before deactivating, and wherein the second charge pump is configured to continue to operate after the first charge pump deactivates.

19. The internal power supply voltage generator of claim 15, wherein
the first voltage stepdown circuit is configured to operate after the first charge pump is operational, and
the second voltage stepdown circuit is configured to operate after the second charge pump is operational.

20. The internal power supply voltage generator of claim 16, wherein
the first voltage stepdown circuit is configured to operate after the first charge pump is operational, and
the second voltage stepdown circuit is configured to operate after the second charge pump is operational.
